(19) United States
(12) Patent Application Publication
(10) Pub. No.: US 2022/0316890 A1
(43) Pub. Date: Oct. 6, 2022

(54) COMPUTER-READABLE RECORDING MEDIUM STORING CHANGE PROGRAM AND CHANGE METHOD FOR MOVING ROUTE, AND INFORMATION PROCESSING APPARATUS

(71) Applicant: FUJITSU LIMITED, Kawasaki-shi (JP)

(72) Inventor: Shingo TOKUNAGA, Kawasaki (JP)

(73) Assignee: FUJITSU LIMITED, Kawasaki-shi (JP)

(21) Appl. No.: 17/583,196

(22) Filed: Jan. 25, 2022

(30) Foreign Application Priority Data
Apr. 1, 2021 (JP) 2021-062760

(51) Int. Cl. G01C 21/34

(52) U.S. Cl. CPC G01C 21/343; G01C 21/3415; G01C 21/3492; G01C 21/3446

(57) ABSTRACT

A moving route change program is disclosed. The program includes steps of detecting to change a moving route of a mobile body that passes through a plurality of destinations planned to be visited by the mobile body, when detecting to change a moving route of a mobile body, acquiring a remaining time to when the mobile body visits, or a remaining time to when the mobile body departs, after visit, a destination unvisited by the mobile body, among the plurality of destinations, determining a destination as a change target that changes a visit plan, among destinations unvisited by the mobile body, on a basis of the acquired remaining time, and changing the moving route of the mobile body on a basis of the determined destination.

### CROSS-REFERENCE TO RELATED APPLICATION

This application is based upon and claims the benefit of priority of the prior Japanese Patent Application No. 2021-062760, filed on Apr. 1, 2021, the entire contents of which are incorporated herein by reference.

### FIELD

The present embodiment discussed herein is related to a change program and a change method for moving route, and an information processing apparatus.

### BACKGROUND

Conventionally, there is a technique of predetermining a moving route of a mobile body that visits a plurality of destinations. For example, in a delivery business, there is a technique for determining a moving route of a delivery vehicle in advance before departure of the delivery vehicle while considering viewpoints such as delivery cost and customer's request for a delivery time zone. A problem of determining a moving route is a type of combinatorial optimization problems.

As an existing technique, for example, there is a technique for calculating a total load amount of packages for each section configured by two departure and arrival bases, and assigning a transport vehicle according to package information and the total load amount to each section. Furthermore, for example, there is a technique for searching a route to a destination starting from a current location of a vehicle. Furthermore, for example, there is a technique for receiving a stop-by request by a passenger who is in a vehicle, determining a stop-by place in response to the stop-by request, and generating a moving route of the vehicle from the current location of the vehicle to the stop-by place. Furthermore, for example, there is a technique for automatically driving a host vehicle on the basis of a travel plan of the host vehicle. Furthermore, for example, there is a technique for transmitting a delivery instruction, which is determined on the basis of a delivery plan and includes at least a visit point and a moving route, to drivers of a plurality of vehicles.

Japanese Laid-open Patent Publication No. 2020-009304, Japanese Laid-open Patent Publication No. 2020-085811, Japanese Laid-open Patent Publication No. 2020-061062, Japanese Laid-open Patent Publication No. 2017-204301, and Japanese Laid-open Patent Publication No. 2020-067677 are disclosed as related art.

### SUMMARY

According to an aspect of the embodiments, a non-transitory computer-readable recording medium storing a moving route change program for causing a computer to execute a process including: detecting to change a moving route of a mobile body that passes through a plurality of destinations planned to be visited by the mobile body; when detecting to change the moving route of a mobile body, acquiring a remaining time to when the mobile body visits, or a remaining time to when the mobile body departs, after visit, a destination unvisited by the mobile body, among the plurality of destinations; determining a destination as a change target that changes a visit plan, among destinations unvisited by the mobile body, on a basis of the acquired remaining time; and changing the moving route of the mobile body on a basis of the determined destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a change method according to an embodiment;

FIG. 2 is an explanatory diagram illustrating one example of an information processing system 200;

FIG. 3 is an explanatory diagram illustrating one example of moving routes;

FIG. 4 is a block diagram illustrating a hardware configuration example of an information processing apparatus 100;

FIG. 5 is an explanatory diagram illustrating one example of stored content in a performance information management table 500;

FIG. 6 is an explanatory diagram illustrating one example of stored content in a mobile body information management table 600;

FIG. 7 is a block diagram illustrating a hardware configuration example of an on-board apparatus 204;

FIG. 8 is a block diagram illustrating a functional configuration example of the information processing apparatus 100;

FIG. 9 is a block diagram illustrating a specific functional configuration example of the information processing apparatus 100;

FIG. 10 is an explanatory diagram (part 1) illustrating a first operation example of the information processing apparatus 100;

FIG. 11 is an explanatory diagram (part 2) illustrating the first operation example of the information processing apparatus 100;

FIG. 12 is an explanatory diagram (part 3) illustrating the first operation example of the information processing apparatus 100;

FIG. 13 is an explanatory diagram (part 4) illustrating the first operation example of the information processing apparatus 100;

FIG. 14 is an explanatory diagram (part 5) illustrating the first operation example of the information processing apparatus 100;

FIG. 15 is an explanatory diagram (part 6) illustrating the first operation example of the information processing apparatus 100;

FIG. 16 is a flowchart illustrating one example of an overall processing procedure in the first operation example;

FIG. 17 is a flowchart illustrating one example of a replanning processing procedure in the first operation example.

FIG. 18 is an explanatory diagram (part 1) illustrating a second operation example of the information processing apparatus 100;

FIG. 19 is an explanatory diagram (part 2) illustrating the second operation example of the information processing apparatus 100;

FIG. 20 is a flowchart illustrating one example of an overall processing procedure in the second operation example; and

FIG. 21 is a flowchart illustrating one example of a replanning processing procedure in the second operation example.

### DESCRIPTION OF EMBODIMENTS

In the existing technique, it is difficult to change the moving route while the mobile body is moving. For example, even during the change of the moving route, the mobile body continues to move and a visiting status to the destinations continues to change, so that the changed moving route may not be an effective moving route.

In one aspect, an object of the present embodiment is to enable a moving route to be appropriately changed in consideration of a moving status of a mobile body.

Hereinafter, an embodiment of a change program, a change method, and an information processing apparatus according to the present embodiment will be described with reference to the drawings.

(Example of Change Method According to Embodiment)

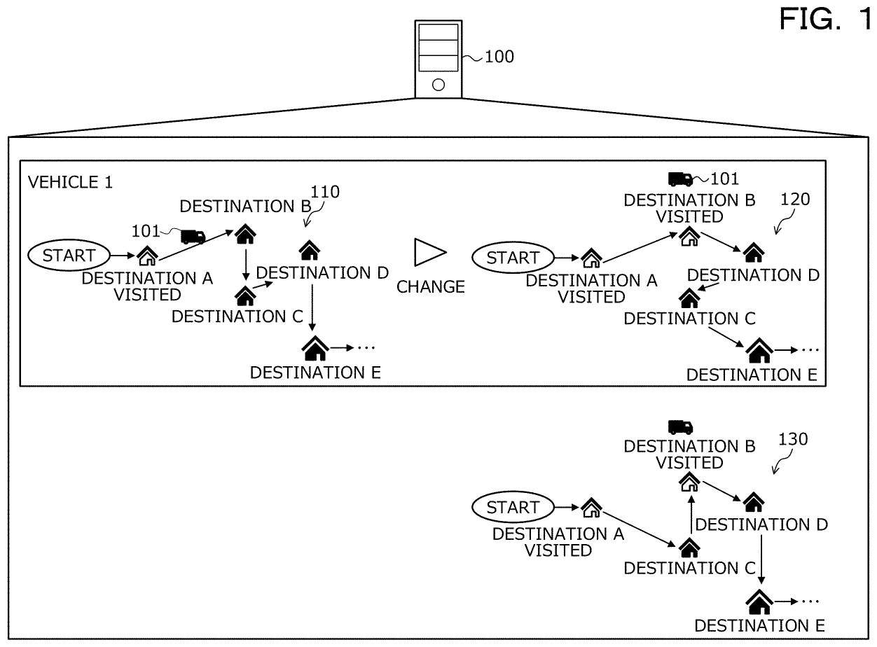

FIG. 1 is an explanatory diagram illustrating an example of a change method according to an embodiment. An information processing apparatus 100 is a computer for appropriately changing a moving route of the mobile body that visits a plurality of destinations. There may be a plurality of mobile bodies, and the plurality of mobile bodies may visit a plurality of destinations in a distributed manner.

Conventionally, the moving route of each mobile body may be determined before the departure of a plurality of mobile bodies. For example, in a delivery business, a moving route of each delivery vehicle may be determined in advance before the departure of a plurality of delivery vehicles while considering viewpoints such as the number of delivery vehicles, the delivery cost, and customer's request for a delivery time zone, and an overall delivery plan may be planned. The delivery cost is, for example, fuel cost, running time, mileage, displacement, or the like. The delivery cost may be, for example, a difficulty in satisfying the customer's request regarding the delivery time zone.

A problem of determining a moving route is a type of combinatorial optimization problems. For the combinatorial optimization problems, for example, an approximate solution method by a mathematical optimization method such as simulated annealing (SA), genetic algorithms (GA), or tabu search is applied.

In the meantime, there is a request to correct the moving route of at least one mobile body during the movement of the plurality of mobile bodies after the departure of the plurality of mobile bodies. For example, a case of desiring correction of the moving route of at least one delivery vehicle during the movement of the plurality of delivery vehicles after the departure of the plurality of mobile bodies is conceivable.

Specifically, a case of desiring correction of the moving route of at least one delivery vehicle due to a change in road conditions such as occurrence of a traffic jam, occurrence of a traffic accident, start of road construction, or start of street closure, is conceivable. Furthermore, specifically, a case of desiring correction of the moving route of at least one delivery vehicle due to a change in delivery status such as adding a new delivery destination, requesting redelivery by the customer, specifying the delivery time zone by the customer, or changing the delivery time by the customer, is conceivable.

However, conventionally, it has been difficult to change the moving route of one mobile body during the movement of the one mobile body. For example, even during execution of determination processing of determining a new moving route of one mobile body, the mobile body keeps moving, and the visiting status to each destination keeps changing. Therefore, the new moving route of one mobile body may not become an effective moving route at the timing when the new moving route of any mobile body has been determined.

In particular, in the case of determining the new moving route of one mobile body by a mathematical optimization method, the time required for the determination processing may increase. For example, the more destinations there are or the more constraints there are related to the delivery time zone or the like, the more likely it is that the time required for the determination processing will increase. Then, as the time required increases, the degree of change in the moving status of one mobile body is likely to increase, the degree of change in the visiting status to each destination is likely to increase, and a probability that a new moving route of the mobile body does not become an effective moving route is likely to increase.

Therefore, in the present embodiment, a change method capable of appropriately changing the moving route of at least one mobile body by narrowing down destinations as change targets for changing a visit plan in consideration of the moving status of the mobile body will be described.

In FIG. 1, a plurality of mobile bodies 101 is present. In the example of FIG. 1, the mobile body 101 is specifically a vehicle i or the like. i is an integer of 1 or larger. Furthermore, there is a plurality of destinations to be visited by the plurality of mobile bodies 101 in a distributed manner. In the example of FIG. 1, there are a destination A, a destination B, a destination C, a destination D, a destination E, and the like.

It is assumed that a moving route of each mobile body 101 is determined before the start of movement of the plurality of mobile bodies 101. The moving route is formed such that the mobile body 101 passes through two or more destinations planned to be visited, for example. Specifically, the moving route of the vehicle 1 is, for example, “the destination A→the destination B→the destination C→the destination D→the destination E→ . . . ” indicated by reference numeral 110. It is assumed that each mobile body 101 starts the movement along the determined moving route of the mobile body 101.

(1-1) The information processing apparatus 100 detects that the moving route of at least one mobile body 101 should be changed. As an event to change the moving route (corresponding to a change trigger to be described below), for example, the information processing apparatus 100 detects that it is favorable to change the moving route of at least one mobile body 101 due to a change in road condition, a change in delivery status, or the like after the start of movement of the plurality of mobile bodies 101. As a result, the information processing apparatus 100 can start change processing of changing the moving route of at least one mobile body 101 at appropriate timing. In the example of FIG. 1, the information processing apparatus 100 detects to change the moving route of the vehicle 1.

(1-2) When detecting to change the moving route of at least one mobile body 101, the information processing apparatus 100 sets the mobile body 101 as a mobile body to be processed. In the example of FIG. 1, the information processing apparatus 100 sets the vehicle 1 as a vehicle to be processed.

The information processing apparatus 100 acquires a remaining time to when the mobile body 101 to be processed departs, after visit, one destination, of destinations unvisited by the mobile body 101, of a plurality of destinations. The one destination is, for example, the destination planned to be visited next by the mobile body 101 to be processed. The information processing apparatus 100 acquires the remaining time to when the mobile body 101 to be processed departs, after visit, the destination planned to be visited next by the mobile body 101, the destination existing on the moving route of the mobile body 101, for example.

Specifically, the information processing apparatus 100 calculates the remaining time to when the mobile body 101 to be processed departs, after visit, the destination planned to be visited next by the mobile body 101 on the basis of an average speed, an average staying time, and the like of the mobile body 101. In the example of FIG. 1, the information processing apparatus 100 calculates the remaining time to when the vehicle 1 departs, after visit, the destination B planned to be visited next by the vehicle 1 on the basis of the average speed, the average staying time, and the like of the vehicle 1. Thereby, the information processing apparatus 100 can obtain the information that serves as a guideline for narrowing down the destinations as change targets for changing the visit plan.

(1-3) The information processing apparatus 100 determines a destination as a change target for changing the visit plan by the mobile body 101 to be processed, among destinations unvisited by the mobile body 101, the destinations existing on the moving route of the mobile body 101, on the basis of the acquired remaining time. The information processing apparatus 100 determines, for example, the destination as change target for changing the visit plan such that the change processing of changing the visit plan can be completed in the acquired remaining time.

In the example of FIG. 1, the information processing apparatus 100 determines the destination C and the destination D as the destinations as change targets for changing the visit plan by the vehicle 1 such that the change processing of changing the visit plan by the vehicle 1 can be completed in the acquired remaining time. Thereby, the information processing apparatus 100 can narrow down the destinations as change targets for changing the visit plan and can appropriately change the moving route of the mobile body 101 to be processed.

(1-4) The information processing apparatus 100 changes the moving route of the mobile body 101 to be processed on the basis of the determined destination. The information processing apparatus 100 changes the moving route of the mobile body 101 to be processed so as to change the visit plan of the determined destination, for example. Specifically, the moving route of the vehicle 1 is changed to, for example, “the destination A→the destination B→the destination D→the destination C→the destination E→ . . . ” indicated by reference numeral 120.

As a result, in changing the moving route of one mobile body 101, the information processing apparatus 100 keeps a partial route to any one of unvisited destinations by the mobile body 101 unchanged, of the moving route of the mobile body 101. Therefore, the information processing apparatus 100 can prevent the changed moving route from not matching the moving status of the mobile body 101 and becoming an ineffective moving route.

Here, conventionally, if the moving route of the vehicle 1 is tried to be changed while the vehicle 1 is moving to the destination B, the moving route of the vehicle 1 is changed without considering the moving status of the vehicle 1. Specifically, conventionally, the moving route of the vehicle 1 is changed to “the destination A→the destination C→the destination B→the destination D→the destination E→ . . . ” indicated by reference numeral 130. However, the vehicle 1 continues to move even while the moving route is being changed, and at the time when the moving route has been changed, the vehicle 1 may have already arrived at the destination B or departed from the destination B. Therefore, the vehicle 1 may not be able to move along the changed moving route. Therefore, the changed moving route may not be an effective moving route.

In contrast, the information processing apparatus 100 considers the moving status of the vehicle 1 and can change the moving route, narrowing down the moving route to the partial route on and after the destination B, of the moving route of the vehicle 1, by the time when the vehicle 1 arrives at and departs the destination B. Specifically, the moving route of the vehicle 1 is changed to “the destination A→the destination B→the destination D→the destination C→the destination E→ . . . ” indicated by reference numeral 120. In this way, the information processing apparatus 100 can change the moving route such that the vehicle 1 can move along the changed moving route. Furthermore, the information processing apparatus 100 can change the moving route such that the changed moving route becomes an effective moving route.

Here, the case in which the information processing apparatus 100 acquires the remaining time to when the mobile body 101 to be processed departs one destination after visit, of unvisited destinations by the mobile body 101, the unvisited destinations existing on the moving route of the mobile body 101, has been described but the embodiment is not limited to the case. For example, there may be case where the information processing apparatus 100 acquires a remaining time to when the mobile body 101 to be processed visits one destination, of destinations unvisited by the mobile body 101, the destinations existing on the moving route of the mobile body 101.

Here, the case in which the information processing apparatus 100 acquires the remaining time to when the mobile body 101 to be processed departs, after visit, the destination planned to be visited next by the mobile body 101, the destination existing on the moving route of the mobile body 101, has been described but the embodiment is not limited to the case. For example, there may be case where the information processing apparatus 100 acquires a remaining time to when the mobile body 101 to be processed departs, after visit, a destination planned to be visited existing n points ahead of the current location of the mobile body 101 on the moving route of the mobile body 101.

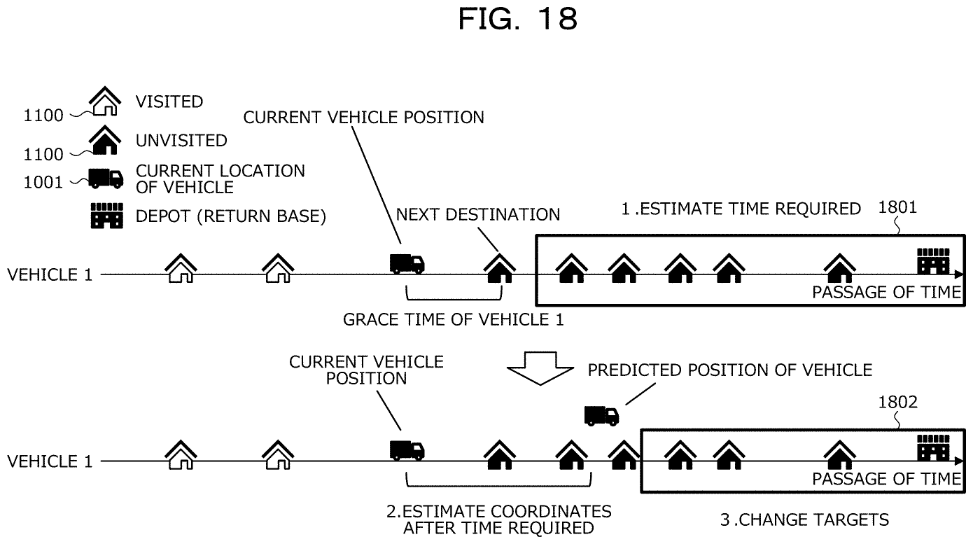

Here, the case in which the information processing apparatus 100 uses the remaining time to when the mobile body 101 to be processed departs, after visit, one destination of unvisited destinations, as the information serving as a guideline for narrowing down the destinations as change targets for changing the visit plan, has been described, but the embodiment is not limited to the case. For example, there may be a case in which the information processing apparatus 100 uses the time required for changing the moving route of the mobile body 101 to be processed as the information serving as a guideline for narrowing down the destinations as change targets for changing the visit plan. Specific examples corresponding to this case will be described below with reference to, for example, FIGS. 18 to 21.

(One Example of Information Processing System 200)

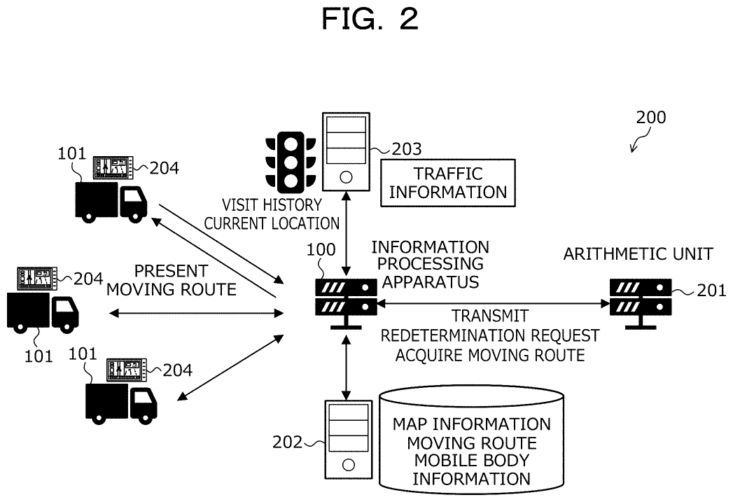

Next, one example of the information processing system 200 to which the information processing apparatus 100 illustrated in FIG. 1 is applied will be described with reference to FIG. 2.

FIG. 2 is an explanatory diagram illustrating one example of the information processing system 200. In FIG. 2, the information processing system 200 includes an information processing apparatus 100, an arithmetic unit 201, an accumulation apparatus 202, a traffic management apparatus 203, and an on-board apparatus 204 mounted on each mobile body 101.

In the information processing system 200, the information processing apparatus 100 and the arithmetic unit 201 are connected via a wired or wireless network. The network is, for example, a local area network (LAN), a wide area network (WAN), the Internet, or the like. Furthermore, the information processing apparatus 100 and the accumulation apparatus 202 are connected via a wired or wireless network. Furthermore, the information processing apparatus 100 and the traffic management apparatus 203 are connected via a wired or wireless network. The information processing apparatus 100 and the on-board apparatus 204 are connected via a wired or wireless network.

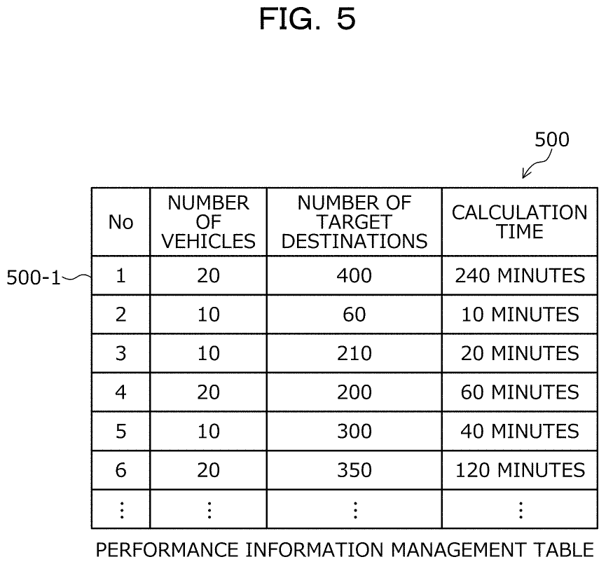

The information processing apparatus 100 is a computer for determining the moving route of each mobile body 101, or changing the moving route of at least one mobile body 101. The information processing apparatus 100 stores, for example, a performance information management table 500, which will be described below in FIG. 5. The performance information management table 500 stores, for example, the time required when determining the moving route in the past. Specifically, the performance information management table 500 stores conditions used when determining the moving route in the past and the time required when determining the moving route in the past in association with each other. The conditions are, for example, the number of mobile bodies 101 and the number of destinations.

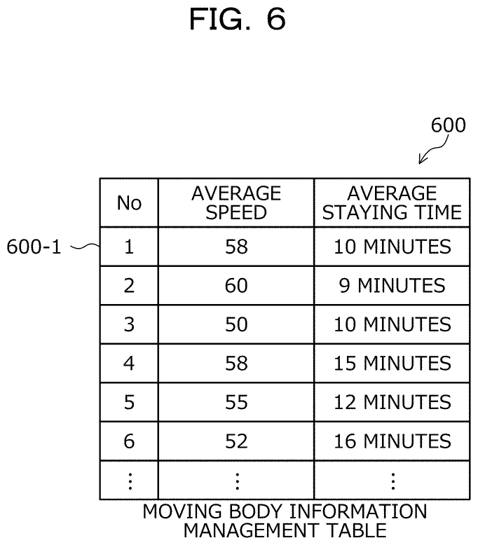

The information processing apparatus 100 receives, for example, map information from the accumulation apparatus 202. The information processing apparatus 100 receives, for example, mobile body information from the accumulation apparatus 202. The mobile body information includes, for example, an average speed of the mobile body 101 and an average staying time of the mobile body 101. The mobile body information is stored in, for example, a mobile body information management table 600, which will be described below in FIG. 6. The information processing apparatus 100 periodically receives traffic information from the traffic management apparatus 203, for example. The traffic information indicates, for example, a road condition. The road condition is, for example, occurrence of a traffic jam, occurrence of a traffic accident, start of road construction, start of street closure, or the like.

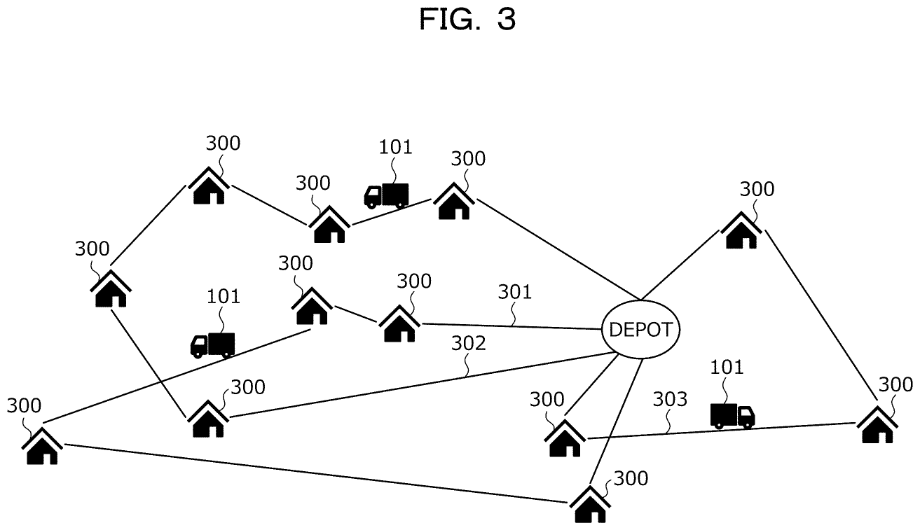

The information processing apparatus 100 transmits, for example, a determination request for determining the initial moving route of each mobile body 101 including the received map information, the received mobile body information, and the received traffic information, to the arithmetic unit 201. The information processing apparatus 100 receives, for example, the initial moving route of each mobile body 101 from the arithmetic unit 201. The information processing apparatus 100 transmits, for example, the initial moving route of each mobile body 101 to the on-board apparatus 204 mounted on the mobile body 101. Furthermore, the information processing apparatus 100 transmits, for example, the initial moving route of each mobile body 101 to the accumulation apparatus 202. An example of the moving route will be described below with reference to, for example, FIG. 3.

The information processing apparatus 100 receives, for example, progress information of each mobile body 101 from the on-board apparatus 204 mounted on the mobile body 101. The progress information includes, for example, a current location of the mobile body 101 and a visit history. The visit history enables specification of a visited destination that the mobile body 101 has already visited and an unvisited destination that the mobile body 101 has not visited yet. The information processing apparatus 100 determines whether to change the moving route of at least one mobile body 101 on the basis of, for example, the progress information of each mobile body 101, the traffic information, and the like.

Furthermore, in a case of receiving the change request for requesting to change the moving route of one mobile body 101 on the basis of an operation input of a user, for example, the information processing apparatus 100 may determine to change the moving route of the mobile body 101. Furthermore, in a case of receiving the change request for requesting to change the moving route of one mobile body 101 from the on-board apparatus 204 mounted on the mobile body 101, the information processing apparatus 100 may determine to change the moving route of the mobile body 101.

When detecting to change the moving route of at least one mobile body 101, for example, the information processing apparatus 100 sets the mobile body 101 as a mobile body to be processed. The information processing apparatus 100 narrows down the destinations as change targets for changing the visit plan, among destinations planned to be visited but unvisited by the mobile body 101 to be processed. Specifically, the information processing apparatus 100 calculates the remaining time to when the mobile body 101 to be processed departs, after visit, the destination planned to be visited next on the basis of the mobile body information of the mobile body 101 and the progress information of the mobile body 101. Then, specifically, the information processing apparatus 100 refers to the performance information management table 500, specifies the number of destinations for which the visit plan is changeable within the calculated remaining time, and narrows down the destinations as change targets for changing the visit plan.

For example, the information processing apparatus 100 transmits a redetermination request for redetermining the moving route of the mobile body 101 to be processed, including the received map information, the received mobile body information, the received traffic information, and the narrowed destinations, to the arithmetic unit 201. The information processing apparatus 100 receives, for example, the moving route of the mobile body 101 to be processed from the arithmetic unit 201. The information processing apparatus 100 transmits, for example, the moving route of the mobile body 101 to be processed to the on-board apparatus 204 mounted on the mobile body 101. Furthermore, the information processing apparatus 100 transmits, for example, the moving route of the mobile body 101 to be processed to the accumulation apparatus 202. For example, the information processing apparatus 100 is a server, a personal computer (PC), or the like.

The arithmetic unit 201 is a computer for determining the moving route of each mobile body 101, or redetermining the moving route of one mobile body 101, under the control of the information processing apparatus 100. The arithmetic unit 201 has a function to solve a combinatorial optimization problem by a mathematical optimization method. The arithmetic unit 201 transmits the determined moving route of each mobile body 101 to the information processing apparatus 100. The arithmetic unit 201 transmits the redetermined moving route of one mobile body 101 to the information processing apparatus 100. The arithmetic unit 201 is, for example, a server or a PC, or the like.

The accumulation apparatus 202 is a computer that manages the map information, moving routes, mobile body information, and the like. The accumulation apparatus 202 provides the information processing apparatus 100 with the map information, moving routes, mobile body information, and the like. The accumulation apparatus 202 is, for example, a server, a PC, or the like. The traffic management apparatus 203 is a computer that manages the traffic information. The traffic management apparatus 203 provides the information processing apparatus 100 with the traffic information. The traffic management apparatus 203 is, for example, a server, a PC, or the like.

The on-board apparatus 204 is a computer mounted on the mobile body 101. The on-board apparatus 204 receives the moving route of the mobile body 101 on which the on-board apparatus itself is mounted from the information processing apparatus 100. The on-board apparatus 204 outputs the moving path of the mobile body 101 on which the on-board apparatus itself is mounted in such a manner that a driver of the mobile body 101 can get the moving route. The on-board apparatus 204 periodically generates the progress information and transmits the progress information to the information processing apparatus 100. The on-board apparatus 204 is, for example, a PC, a tablet terminal, a smartphone, a car navigation apparatus, or the like.

Herein, the case in which the information processing apparatus 100 and the arithmetic unit 201 are different apparatuses has been described. However, the present embodiment is not limited to the case. For example, there may be a case in which the information processing apparatus 100 has a function as the arithmetic unit 201. In this case, the information processing system 200 may not include the arithmetic unit 201.

Herein, the case in which the information processing apparatus 100 and the accumulation apparatus 202 are different apparatuses has been described. However, the present embodiment is not limited to the case. For example, there may be a case in which the information processing apparatus 100 has a function as the accumulation apparatus 202. In this case, the information processing system 200 may not include the accumulation apparatus 202.

Here, the case in which the information processing apparatus 100 and the traffic management apparatus 203 are different apparatuses has been described, but the present embodiment is not limited to this case. For example, there may be a case in which the information processing apparatus 100 has a function as the traffic management apparatus 203. In this case, the information processing system 200 may not include the traffic management apparatus 203.

(One Example of Moving Routes)

Next, one example of the moving routes will be described with reference to FIG. 3.

FIG. 3 is an explanatory diagram illustrating one example of moving routes. In FIG. 3, the information processing apparatus 100 determines moving routes 301 to 303 of the mobile bodies 101. The information processing apparatus 100 determines the moving routes 301 to 303 of the mobile bodies 101 such that a cumulative travel time or a cumulative travel distance becomes short according to a predetermined algorithm. As illustrated in FIG. 3, the moving routes 301 to 303 are formed so as to pass through two or more destinations 300. A first starting point of the moving routes 301 to 303 is a depot. The depot is, for example, a delivery base. A final arrival point of the moving routes 301 to 303 is the depot. Therefore, the moving routes 301 to 303 are, for example, closed paths.

(Hardware Configuration Example of Information Processing Apparatus 100)

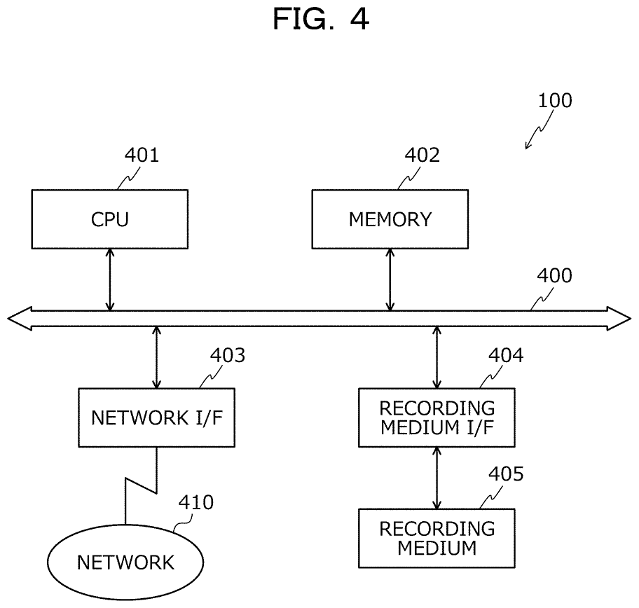

Next, a hardware configuration example of the information processing apparatus 100 will be described with reference to FIG. 4.

FIG. 4 is a block diagram illustrating a hardware configuration example of the information processing apparatus 100. In FIG. 4, the information processing apparatus 100 includes a central processing unit (CPU) 401, a memory 402, a network interface (I/F) 403, a recording medium I/F 404, and a recording medium 405. Furthermore, the respective configuration units are connected to each other by a bus 400.

Here, the CPU 401 is in charge of overall control of the information processing apparatus 100. The memory 402 has, for example, a read only memory (ROM), a random access memory (RAM), a flash ROM, and the like. Specifically, for example, the flash ROM or the ROM stores various types of programs, while the RAM is used as a work area for the CPU 401. The programs stored in the memory 402 are loaded into the CPU 401 to cause the CPU 401 to execute coded processing.

The network I/F 403 is connected to the network 410 through a communication line, and is connected to another computer through the network 410. Then, the network I/F 403 manages an interface between the network 410 and an inside, and controls input and output of data to and from another computer. For example, the network I/F 403 is a modem, a LAN adapter, or the like.

The recording medium I/F 404 controls reading and writing of data from and to the recording medium 405 under the control of the CPU 401. For example, the recording medium I/F 404 is a disk drive, a solid state drive (SSD), a universal serial bus (USB) port, or the like. The recording medium 405 is a nonvolatile memory that stores data written under the control of the recording medium I/F 404. For example, the recording medium 405 is a disk, a semiconductor memory, a USB memory, or the like. The recording medium 405 may be attachable to and detachable from the information processing apparatus 100.

For example, the information processing apparatus 100 may include a keyboard, a mouse, a display, a printer, a scanner, a microphone, a speaker, or the like in addition to the configuration units described above. Furthermore, the information processing apparatus 100 may include a plurality of the recording medium I/Fs 404 and the recording medium 405. In addition, the information processing apparatus 100 does not have to include the recording medium I/F 404 or the recording medium 405.

(Stored Content in Performance Information Management Table 500)

Next, one example of stored content in the performance information management table 500 will be described with reference to FIG. 5. The performance information management table 500 is implemented by a storage area such as the memory 402 or the recording medium 405 of the information processing apparatus 100 illustrated in FIG. 4, for example.

FIG. 5 is an explanatory diagram illustrating one example of stored content in the performance information management table 500. As illustrated in FIG. 5, the performance information management table 500 has fields of No, the number of vehicles, the number of target destinations, and calculation time. In the performance information management table 500, performance information is stored as a record 500-a by setting information in each field every time a moving route is determined. a represents an arbitrary integer.

In the field of No, a number of the record is set. In the field of the number of vehicles, the number of vehicles indicating how many moving routes of mobile bodies have been determined when the moving route of each mobile body of one or more mobile bodies has been determined in the past is set. In other words, the number of vehicles is one of the conditions used in the past to determine the moving route of each mobile body of one or more mobile bodies.

In the field of the number of target destinations, the number of target destinations indicating how many destinations as a whole the moving route of each mobile body has been determined when the moving route of each mobile body of one or more mobile bodies has been determined in the past is set. In other words, the number of target destinations is one of the conditions used in the past to determine the moving route of each mobile body of one or more mobile bodies. In the field of calculation time, the calculation time when the moving route is determined in the past is set.

(Stored Content in Mobile Body Information Management Table 600)

Next, one example of stored content in the mobile body information management table 600 will be described with reference to FIG. 6. The mobile body information management table 600 is implemented by the storage area such as the memory 402 or the recording medium 405 of the information processing apparatus 100 illustrated in FIG. 5, for example.

FIG. 6 is an explanatory diagram illustrating one example of stored content in the mobile body information management table 600. As illustrated in FIG. 6, the mobile body information management table 600 has fields of No, average speed, and average staying time. In the mobile body information management table 600, mobile body information is stored as a record 600-b by setting information in each field for each mobile body. The letter b represents an arbitrary integer.

In the field of No, a number of the mobile body is set. In the field of average speed, an average speed of the mobile body is set. The unit of average speed is, for example, speed per hour. In the field of average staying time, an average staying time of the mobile body at visited destinations is set. The unit of average staying time is, for example, minutes. The average staying time is calculated on the basis of, for example, the time from when the mobile body stops to when the mobile body resumes moving at each destination of the plurality of destinations in the past. The average staying time is calculated on the basis of, for example, the time from when the power of the mobile body is stopped to when the mobile body is restarted at each destination of the plurality of destinations in the past. The power is, for example, an engine. The average staying time is calculated on the basis of, for example, the time from when the on-board apparatus 204 mounted on the mobile body is stopped to when the on-board apparatus is reactivated at each destination of the plurality of destinations in the past.

(Hardware Configuration Example of Arithmetic Unit 201)

Specifically, since the hardware configuration example of the arithmetic unit 201 is similar to the hardware configuration example of the information processing apparatus 100 illustrated in FIG. 4, description thereof will be omitted.

(Hardware Configuration Example of Accumulation Apparatus 202)

Specifically, since the hardware configuration example of the accumulation apparatus 202 is similar to the hardware configuration example of the information processing apparatus 100 illustrated in FIG. 4, description thereof will be omitted.

(Hardware Configuration Example of Traffic Management Apparatus 203)

Specifically, since the hardware configuration example of the traffic management apparatus 203 is similar to the hardware configuration example of the information processing apparatus 100 illustrated in FIG. 4, the description thereof will be omitted.

(Hardware Configuration Example of On-Board Apparatus 204)

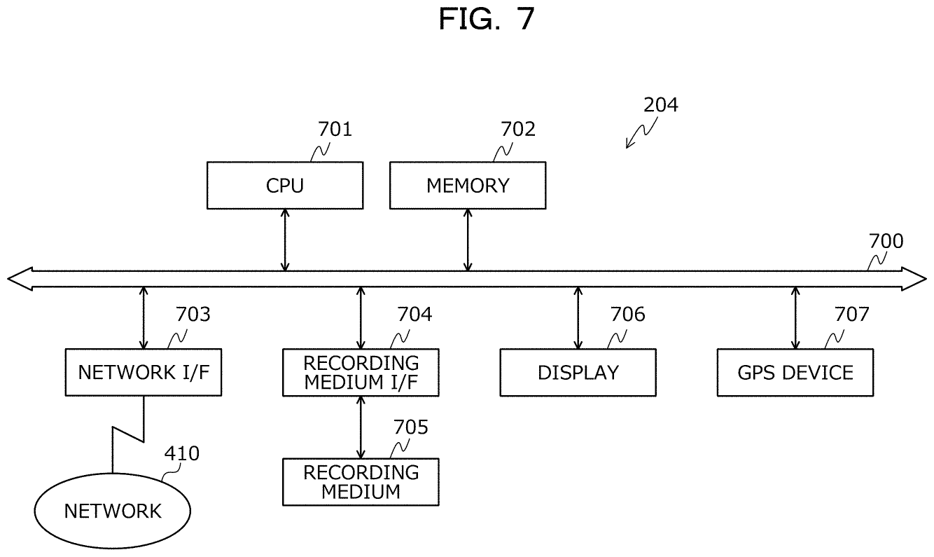

Next, a hardware configuration example of the on-board apparatus 204 included in the information processing system 200 illustrated in FIG. 2 will be described with reference to FIG. 7.

FIG. 7 is a block diagram illustrating a hardware configuration example of the on-board apparatus 204. In FIG. 7, the on-board apparatus 204 includes a CPU 701, a memory 702, a network I/F 703, a recording medium I/F 704, a recording medium 705, a display 706, and a global positioning system (GPS) device 707. Furthermore, the respective configuration units are connected to each other by a bus 700.

Here, the CPU 701 performs overall control of the on-board apparatus 204. The memory 702 includes, for example, a ROM, a RAM, a flash ROM, and the like. Specifically, for example, the flash ROM or the ROM stores various types of programs, while the RAM is used as a work area for the CPU 701. The programs stored in the memory 702 are loaded into the CPU 701 to cause the CPU 701 to execute coded processing.

The network I/F 703 is connected to the network 410 through a communication line, and is connected to another computer through the network 410. Then, the network I/F 703 manages an interface between the network 410 and an inside, and controls input and output of data to and from another computer. For example, the network I/F 703 is a modem, a LAN adapter, or the like.

The recording medium I/F 704 controls reading and writing of data from and to the recording medium 705 under the control of the CPU 701. The recording medium I/F 704 is, for example, a disk drive, an SSD, a USB port, or the like. The recording medium 705 is a nonvolatile memory that stores data written under the control of the recording medium I/F 704. For example, the recording medium 705 is a disk, a semiconductor memory, a USB memory, or the like. The recording medium 705 may be attachable to and detachable from the on-board apparatus 204.

The display 706 displays data such as a document, an image, and function information, as well as a cursor, an icon, or a tool box. The display 706 is, for example, a cathode ray tube (CRT), a liquid crystal display, an organic electroluminescence (EL) display, or the like. The GPS device 707 detects radio waves of GPS satellites. The GPS device 707 detects coordinates of the on-board apparatus 204 on the basis of the radio waves of the GPS satellites.

The on-board apparatus 204 may have, for example, a keyboard, a mouse, a display, a printer, a scanner, a microphone, a speaker, and the like in addition to the above-described configuration units. Further, the on-board apparatus 204 may have a plurality of the recording medium I/Fs 704 and a plurality of the recording media 705. Furthermore, the on-board apparatus 204 does not have to include the recording medium I/F 704 and the recording medium 705.

(Functional Configuration Example of Information Processing Apparatus 100)

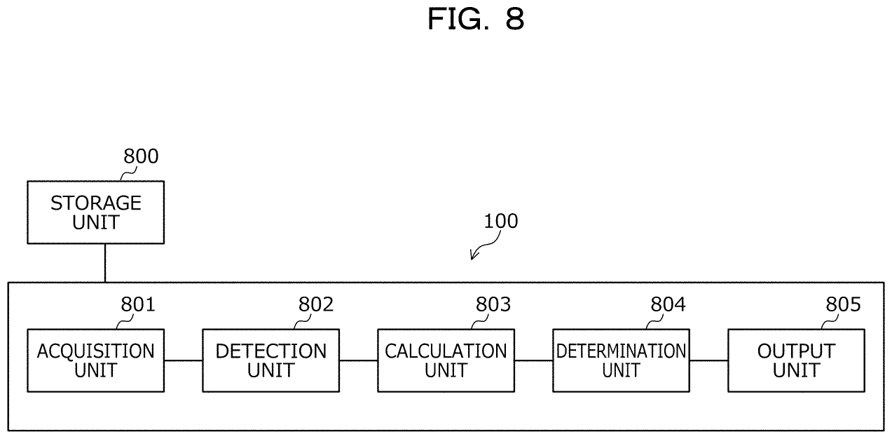

Next, a functional configuration example of the information processing apparatus 100 will be described with reference to FIG. 8.

FIG. 8 is a block diagram illustrating a functional configuration example of the information processing apparatus 100. The information processing apparatus 100 includes a storage unit 800, an acquisition unit 801, a detection unit 802, a calculation unit 803, a determination unit 804, and an output unit 805.

The storage unit 800 is implemented by, for example, the storage area such as the memory 402 or the recording medium 405 illustrated in FIG. 4. Hereinafter, a case where the storage unit 800 is included in the information processing apparatus 100 will be described. However, the storage unit 800 is not limited to this case. For example, there may be a case where the storage unit 800 is included in a apparatus different from the information processing apparatus 100, and the information processing apparatus 100 is allowed to refer to the stored contents of the storage unit 800.

The acquisition unit 801 to the output unit 805 function as an example of a control unit. Specifically, for example, the acquisition unit 801 to the output unit 805 implement functions thereof by causing the CPU 401 to execute a program stored in the storage area such as the memory 402 or the recording medium 405 illustrated in FIG. 4 or by the network I/F 403. A processing result of each functional unit is stored in the storage area such as the memory 402 or the recording medium 405 illustrated in FIG. 4, for example.

The storage unit 800 stores various types of information referred to or updated in the processing of each functional unit. The storage unit 800 stores the traffic information. The traffic information indicates, for example, a road condition. The road condition is, for example, occurrence of a traffic jam, occurrence of a traffic accident, start of road construction, start of street closure, or the like. The traffic information is acquired by, for example, the acquisition unit 801.

The storage unit 800 stores, for example, destination information including positions of respective destinations of the plurality of destinations. The destination is, for example, a delivery destination or a collection destination. The position of the destination is, for example, the coordinates of the destination. The destination is set by the user, for example. The destination information may further include a restriction on a visit time zone to the destination. The destination information is acquired by, for example, the acquisition unit 801.

The storage unit 800 stores, for example, the mobile body information including the average speed, the average staying time, and the like of each mobile body of the plurality of mobile bodies. Specifically, the storage unit 800 stores the mobile body information, using the mobile body information management table 600. The mobile body information is acquired by, for example, the acquisition unit 801.

The storage unit 800 stores the moving route of each mobile body. The moving route is, for example, a moving plan of the mobile body. The moving route is formed such that the mobile body passes through two or more destinations planned to be visited, for example. The storage unit 800 stores the moving route of each mobile body currently being adopted. The moving route is generated by, for example, the determination unit 804.

The storage unit 800 stores the progress information including, for example, the position and the visit history of each mobile body of the plurality of mobile bodies. The position of the mobile body is, for example, the coordinates of the mobile body. The visit history enables specification of a visited destination that the mobile body has already visited and an unvisited destination that the mobile body has not visited yet. The progress information is acquired by, for example, the acquisition unit 801.

The storage unit 800 stores a model for enabling calculation of a processing time required for the change processing. The change processing is processing of changing the visit plan for at least one destination in order to change the moving route of a mobile body. The model is, for example, a mathematical expression. The model may be, for example, a neural network.

The model is, for example, a mathematical expression for calculating the processing time required for the change processing of changing the visit plan for each destination according to the number of destinations for which the visit plan is to be changed. The model may be, for example, a mathematical expression for calculating the processing time required for the change processing of changing the visit plan for each destination according to the number of mobile bodies and the number of destinations for which the visit plan is to be changed. The model is generated by, for example, the calculation unit 803 on the basis of the performance information management table 500. The model is acquired by, for example, the acquisition unit 801.

The storage unit 800 stores time information that serves as a guideline for narrowing down the destinations as change targets for changing the visit plan. The time information is, for example, the remaining time to when a mobile body visits one destination, of unvisited destinations by the mobile body, the unvisited destinations existing on the moving route of the mobile body, or the remaining time to when the mobile body departs, after visit, the destination. The time information is, for example, the time required for changing the moving route of each mobile body of one or more mobile bodies. The time information is calculated by, for example, the calculation unit 803. The time information is acquired by, for example, the acquisition unit 801.

The acquisition unit 801 acquires various types of information to be used for the processing of each functional unit. The acquisition unit 801 stores the acquired various types of information in the storage unit 800 or outputs the acquired various types of information to each functional unit. Furthermore, the acquisition unit 801 may output the various sorts of information stored in the storage unit 800 to each functional unit. The acquisition unit 801 acquires the various types of information on the basis of, for example, the user's operation input. The acquisition unit 801 may receive the various sorts of information from a apparatus different from the information processing apparatus 100, for example.

The acquisition unit 801 acquires, for example, the traffic information. The acquisition unit 801 acquires, specifically, the traffic information by receiving the traffic information from the another computer. Another computer is, for example, the traffic management apparatus 203. The traffic information is used when, for example, the detection unit 802 detects to change the moving route of at least one mobile body. The traffic information is used when, for example, the calculation unit 803 generates the time information. The traffic information is used when, for example, the determination unit 804 determines the moving route of each mobile body of one or more mobile bodies.

The acquisition unit 801 acquires, for example, the destination information. The acquisition unit 801 acquires the destination information by accepting an input of the destination information on the basis of the user's operation input, for example. The destination information is used when, for example, the detection unit 802 detects to change the moving route of at least one mobile body. The destination information is used when, for example, the calculation unit 803 generates the time information. The destination information is used when, for example, the determination unit 804 determines the moving route of each mobile body of one or more mobile bodies.

The acquisition unit 801 acquires, for example, the mobile body information. Specifically, the acquisition unit 801 acquires the mobile body information by accepting an input of the mobile body information on the basis of the user's operation input. The mobile body information is used when, for example, the detection unit 802 detects to change the moving route of at least one mobile body. The mobile body information is used when, for example, the calculation unit 803 generates the time information. The mobile body information is used when, for example, the determination unit 804 determines the moving route of each mobile body of one or more mobile bodies.

The acquisition unit 801 acquires, for example, the progress information of each mobile body. Specifically, the acquisition unit 801 acquires the progress information of each mobile body by receiving the progress information of each mobile body from another computer. Another computer is, for example, the on-board apparatus 204 mounted on the mobile body. The progress information is used when, for example, the detection unit 802 detects to change the moving route of at least one mobile body. The progress information is used when, for example, the calculation unit 803 generates the time information. The progress information is used when, for example, the determination unit 804 determines the moving route of each mobile body of one or more mobile bodies.

The acquisition unit 801 acquires, for example, the model for enabling calculation of the processing time required for the change processing. Specifically, for example, the acquisition unit 801 acquires the model by receiving the model from another computer. Specifically, the acquisition unit 801 acquires the model by accepting an input of the model on the basis of the user's operation input. The model is used when, for example, the calculation unit 803 generates the time information. The model is used when, for example, the determination unit 804 determines the moving route of each mobile body of one or more mobile bodies.

The acquisition unit 801 acquires, for example, the time information. The acquisition unit 801 acquires, specifically, the time information by receiving the time information from another computer. Another computer is, for example, the on-board apparatus 204 mounted on the mobile body. Specifically, the acquisition unit 801 receives the time information from another computer when the calculation unit 803 does not generate the time information. The time information is used when, for example, the determination unit 804 determines the moving route of each mobile body of one or more mobile bodies.

The acquisition unit 801 acquires, for example, a change request for requesting to change the moving route of at least one mobile body. The change request may include, for example, identification information that identifies the mobile body, which makes it possible to specify which mobile body's moving route is to be changed. Specifically, the acquisition unit 801 acquires the change request by accepting an input of the change request on the basis of the user's operation input. The acquisition unit 801 acquires, specifically, the change request by receiving the change request from another computer. Another computer is, for example, the on-board apparatus 204 mounted on one mobile body.

The acquisition unit 801 acquires, for example, an update request for requesting addition or deletion of a destination or change of the restriction on the visit time zone. For example, the deletion of a destination occurs when the visit plan for the destination is canceled or when the visit plan for the destination is postponed tomorrow or after tomorrow, for example. The acquisition unit 801 acquires, specifically, the update request by receiving the update request from another computer. Specifically, the acquisition unit 801 may update the destination information stored in the storage unit 800 in response to the update request.

The acquisition unit 801 may accept a start trigger to start the processing of any one of the functional units. The start trigger is, for example, a predetermined operation input made by the user. The start trigger may be, for example, reception of predetermined information from another computer. The start trigger may be, for example, output of predetermined information by one of the functional units.

The detection unit 802 detects to change the moving route of at least one mobile body. The detection unit 802 detects a need to change the moving route of at least one mobile body on the basis of at least one of the traffic information, the destination information, the mobile body information, and the progress information acquired by the acquisition unit 801, for example.

Specifically, the detection unit 802 determines whether a traffic jam, a traffic accident, a street closure, or the like has occurred on the moving route of each mobile body on the basis of the traffic information. Then, specifically, when it is determined that a traffic jam, a traffic accident, a street closure, or the like has occurred on the moving route of one mobile body, the detection unit 802 detects to change the moving route of the mobile body Thereby, the detection unit 802 enables the moving route of one mobile body to be changed at appropriate timing.

Specifically, the detection unit 802 determines whether a prediction value at the time when any mobile body visits any destination satisfies the restriction on the visit time zone on the basis of the traffic information, the destination information, the mobile body information, and the progress information. Then, in a case of determining that the prediction value at the time when one mobile body visits one destination does not satisfy the restriction on the visit time zone, the detection unit 802 detects to change the moving route of the mobile body. Thereby, the detection unit 802 enables the moving route of one mobile body to be changed at appropriate timing.

For example, the detection unit 802 may detect to change the moving route of one mobile body in response to acquisition of the change request or the update request by the acquisition unit 801. Thereby, the detection unit 802 can detect to collectively change the moving route of one mobile body, and enables the moving route of one mobile body to be changed at appropriate timing.

When detecting to change the moving route of at least one mobile body, the calculation unit 803 sets the mobile body as a mobile body to be processed and generates the time information regarding the mobile body. For example, there may be a plurality of mobile bodies to be processed.

For example, the calculation unit 803 calculates the remaining time to when each mobile body to be processed visits one destination unvisited by the mobile body, the destination presenting on the moving route of the mobile body, among the plurality of destinations. Specifically, the calculation unit 803 calculates the remaining time to when each mobile body to be processed visits the destination planned to be visited by the mobile body n points later on the basis of the traffic information, the destination information, the mobile body information, and the progress information, for example. n is an integer of 1 or larger. More specifically, the calculation unit 803 calculates the remaining time to when each mobile body to be processed departs the destination planned to be visited next by the mobile body. Thereby, the calculation unit 803 can obtain the information that serves as a guideline for narrowing down the destinations as change targets for changing the visit plan when the determination unit 804 determines the moving route of each mobile body to be processed.

For example, the calculation unit 803 calculates the remaining time to when each mobile body to be processed departs, after visit, one destination unvisited by the mobile body, the destination presenting on the moving route of the mobile body, among the plurality of destinations. Specifically, the calculation unit 803 calculates the remaining time to when each mobile body to be processed departs, after visit, the destination planned to be visited by the mobile body n points later on the basis of the traffic information, the destination information, the mobile body information, and the progress information, for example. More specifically, the calculation unit 803 calculates the remaining time to when each mobile body to be processed departs, after visit, the destination planned to be visited next by the mobile body. Thereby, the calculation unit 803 can obtain the information that serves as a guideline for narrowing down the destinations as change targets for changing the visit plan when the determination unit 804 determines the moving route of each mobile body to be processed.

The calculation unit 803 acquires the time required for changing the moving route of each mobile body to be processed on the basis of the destinations unvisited by the mobile body, among the plurality of destinations. The calculation unit 803 acquires the time required for changing the moving route of each mobile body to be processed on the basis of the destinations unvisited by the mobile body by reference to the progress information using the model, for example. Specifically, the calculation unit 803 acquires the time required for changing the moving route of each mobile body to be processed, which is output from the model, by inputting the number of destinations unvisited by the mobile body to the model. Thereby, the calculation unit 803 can obtain the information that serves as a guideline for narrowing down the destinations as change targets for changing the visit plan when the determination unit 804 determines the moving route of each mobile body to be processed.

The calculation unit 803 generates the model or updates the model. After the movement of each mobile body is completed, the calculation unit 803 generates the model or updates the model on the basis of the destination information, the mobile body information, and the progress information. Thereby, the calculation unit 803 can improve the accuracy of the model and can accurately calculate the time required for changing the moving route of each mobile body.

The determination unit 804 determines, for each mobile body to be processed, the destinations as change targets for changing the visit plan by the mobile body, among the destinations existing on the moving route of the mobile body, on the basis of the time information acquired by the acquisition unit 801 or calculated by the calculation unit 803.

For example, the determination unit 804 determines, for each mobile body to be processed, the destinations as the change targets, among the destinations existing on the moving route of the mobile body and unvisited by the mobile body, on the basis of the remaining time acquired for the mobile body.

Specifically, the determination unit 804 specifies, for the mobile body to be processed, the number of destinations for which the visit plan is changeable in the remaining time, among the destinations existing on the moving route of the mobile body and unvisited by the mobile body, using the model. Then, the determination unit 804 specifically determines the destinations as change targets for changing the visit plan on the basis of the specified number.

More specifically, the determination unit 804 acquires, for the mobile body to be processed, the number of destinations output from the model by inputting the remaining time to the model, and sets the acquired number as the number of destinations for which the visit plan by the mobile body is changeable. Then, more specifically, the determination unit 804 selects the specified number of unvisited destinations included in an area corresponding to the mobile body to be processed, and determines the selected destinations as the destinations as change targets for changing the visit plan by the mobile body.

The area is, for example, an area with the destination planned to be visited by the mobile body as a reference point. The area may be, for example, an area with the starting point at which the mobile body first departs as a reference point. The area may be, for example, an area with the arrival point at which the mobile body finally arrives as a reference point. The area is set on the basis of a linear distance from the reference point. The area is, for example, circular. The area is set on the basis of the travel time from the reference point.

At this time, more specifically, the determination unit 804 expands the area corresponding to the mobile body to be processed until the number of destinations unvisited by the mobile body included in the area exceeds the number specified for the mobile body. Then, more specifically, the determination unit 804 selects the specified number of unvisited destinations included in the expanded area, and determines the selected destinations as the destinations as change targets for changing the visit plan by the mobile body to be processed. Thereby, the determination unit 804 can narrow down the destinations as change targets for changing the visit plan and can appropriately change the moving route of each mobile body to be processed.

For example, the determination unit 804 determines, for each mobile body to be processed, the destinations as the change targets for changing the visit plan by the mobile body, among the destinations unvisited by the mobile body, on the basis of the time required acquired for the mobile body.

Specifically, the determination unit 804 specifies, for the mobile body to be processed, the visitable destinations in the time required acquired for the mobile body and the mobile body planned to be visited next after the acquired time required, of the destinations unvisited by the mobile body. The determination unit 804 determines, for the mobile body to be processed, the remaining destinations excluding the specified destinations, among the destinations unvisited by the mobile body, as the destinations as change targets for changing the visit plan, Thereby, the determination unit 804 can narrow down the destinations as change targets for changing the visit plan and can appropriately change the moving route of each mobile body to be processed.

The determination unit 804 changes the moving route of each mobile body to be processed on the basis of the determined destinations. The determination unit 804 determines a new moving route of each mobile body to be processed and changes the moving route of each mobile body by changing the visit plan of the determined destinations without changing the visit plan of the destinations other than the determined determinations. Thereby, the determination unit 804 can appropriately change the moving route of each mobile body to be processed.

The determination unit 804 may cause, for example, the arithmetic unit 201 to determine the new moving route of each mobile body to be processed by transmitting the determined destinations to the arithmetic unit 201, and acquire the new moving route of each mobile body to be processed from the arithmetic unit 201. Thereby, the determination unit 804 can appropriately change the moving route of each mobile body to be processed.

Furthermore, the determination unit 804 may determine the initial moving route of each mobile body of a plurality of mobile bodies. As a result, the determination unit 804 can allow each mobile body of the plurality of mobile bodies to start moving.

The output unit 805 outputs a processing result of at least any one of the functional units. An output format is, for example, display on a display, print output to a printer, transmission to an external apparatus by the network I/F 403, or storage in the storage area such as the memory 402 or the recording medium 405. Thereby, the output unit 805 enables the processing result of at least one of the functional units to be notified to the user and can improve the convenience of the information processing apparatus 100.

The output unit 805 outputs the moving route of the mobile body determined by the determination unit 804. The output unit 805 transmits, for example, the moving route of the mobile body to the on-board apparatus 204 mounted on the mobile body. As a result, the output unit 805 can appropriately move the mobile body along the determined moving route of the mobile body.

(Specific Functional Configuration Example of Information Processing Apparatus 100)

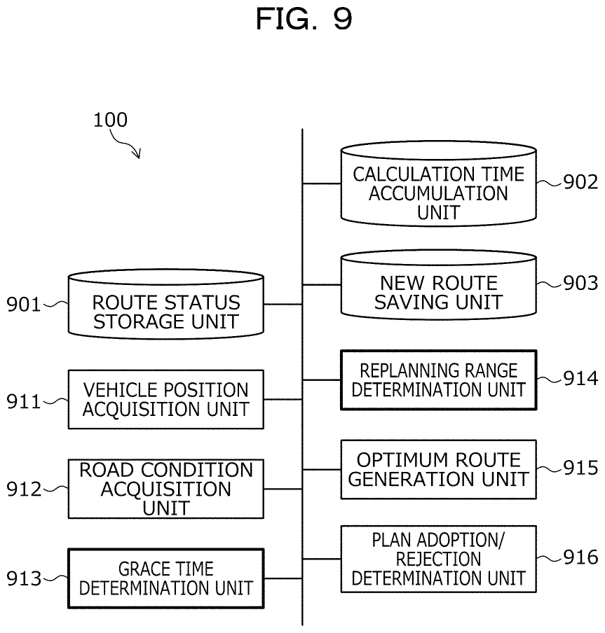

Next, a specific functional configuration example of the information processing apparatus 100 will be described with reference to FIG. 9.

FIG. 9 is a block diagram illustrating a specific functional configuration example of the information processing apparatus 100. The information processing apparatus 100 includes a route status storage unit 901, a calculation time accumulation unit 902, and a new route saving unit 903. Furthermore, the information processing apparatus 100 includes a vehicle position acquisition unit 911, a road condition acquisition unit 912, a grace time determination unit 913, a replanning range determination unit 914, an optimum route generation unit 915, and a plan adoption/rejection determination unit 916.

The route status storage unit 901 stores, for example, the coordinates of a delivery vehicle acquired by the GPS device of the delivery vehicle. The route status storage unit 901 stores, for example, flag information indicating whether the delivery vehicle has already visited each delivery destination planned to be visited. The route status storage unit 901 stores, for example, traffic information acquired from vehicle information and communication system (VICS). VICS is a registered trademark.

The calculation time accumulation unit 902 stores, for example, conditions and a time required when a delivery plan was drawn up in the past. The delivery plan includes the moving route of each delivery vehicle. The drawing up the plan is to determine the moving route of each delivery vehicle. The conditions are the number of delivery vehicles, the number of delivery destinations, and the like. The new route saving unit 903 stores, for example, the latest delivery plan. Specifically, the new route saving unit 903 stores the latest moving route of each delivery vehicle as the latest delivery plan.

The vehicle position acquisition unit 911 receives, for example, the coordinates of the delivery vehicle acquired from the GPS device of the delivery vehicle from the on-board apparatus 204 mounted on the delivery vehicle. The vehicle position acquisition unit 911 stores, for example, the received coordinates of the delivery vehicle in the route status storage unit 901. The vehicle position acquisition unit 911 receives, for example, the flag information indicating whether the delivery vehicle has already visited each delivery destination planned to be visited from the on-board apparatus 204 mounted on the delivery vehicle. The vehicle position acquisition unit 911 stores, for example, the received flag information in the route status storage unit 901. The road condition acquisition unit 912 acquires the traffic information from the VICS, for example. The road condition acquisition unit 912 stores the acquired traffic information in the route status storage unit 901.

The grace time determination unit 913 determines, for example, the delivery vehicle to be processed. The delivery vehicle to be processed is a vehicle for changing the moving route. The grace time determination unit 913 determines, for example, the grace time that can be used for changing the moving route of each delivery vehicle to be processed. Specifically, the grace time determination unit 913 calculates, for each delivery vehicle to be processed, the remaining time to when the delivery vehicle departs, after visit, the delivery destination planned to be visited next, on the basis of the coordinates of the delivery vehicle, the flag information of the delivery vehicle, and the traffic information. Specifically, the grace time determination unit 913 adopts the remaining time calculated for each delivery vehicle to be processed as the grace time that can be used for changing the moving route of the delivery vehicle.

For example, for each delivery vehicle to be processed, the grace time determination unit 913 may determine the time required for changing the moving route of the delivery vehicle on the basis of the delivery destinations unvisited by the delivery vehicle. Specifically, the grace time determination unit 913 generates a model for determining the time required with reference to the calculation time accumulation unit 902. Then, specifically, the grace time determination unit 913 determines the time required for changing the moving route of each delivery vehicle to be processed on the basis of the delivery destinations unvisited by the delivery vehicle, using the generated model.

For example, the replanning range determination unit 914 determines, for each delivery vehicle to be processed, delivery destinations as change targets for changing the visit plan by the delivery vehicle in order to change the moving route of the delivery vehicle, among the delivery destinations unvisited by the delivery vehicle, on the basis of the grace time determined for the delivery vehicle. Specifically, the replanning range determination unit 914 specifies, for each delivery vehicle to be processed, an upper limit of the number of delivery destinations as change targets by the delivery vehicle, for which change of the moving route of the delivery vehicle can be completed in the grace time determined for the delivery vehicle. Then, the replanning range determination unit 914 determines, for each delivery vehicle to be processed, delivery destinations as change targets for changing the visit plan by the delivery vehicle, among the delivery destinations unvisited by the delivery vehicle, in a range equal to or less than the specified upper limit.

The optimum route generation unit 915 draws up, for example, an initial delivery plan. The drawing up the plan is to determine the moving route of each delivery vehicle. Specifically, the optimum route generation unit 915 draws up the initial delivery plan by using a mathematical optimization method. For example, the optimum route generation unit 915 changes, for each delivery vehicle to be processed, the moving route of the delivery vehicle on the basis of the delivery destination as change target for changing the determined visit plan. Specifically, the optimum route generation unit 915 changes, for each delivery vehicle to be processed, the visit plan for the delivery destination as change target for changing the visit plan by the delivery vehicle, using a mathematical optimization method. The optimum route generation unit 915 newly draws up a delivery plan by changing the moving route of each delivery vehicle to be processed.

The plan adoption/rejection determination unit 916 determines, for example, whether to adopt the delivery plan drawn up by the optimum route generation unit 915. Specifically, the plan adoption/rejection determination unit 916 adopts the newly drawn-up delivery plan if the newly drawn-up delivery plan is more appropriate than the currently adopted delivery plan. Appropriate means, for example, that the delivery cost is relatively low. Furthermore, the plan adoption/rejection determination unit 916 adopts the newly drawn-up delivery plan if the delivery plan being adopted is inappropriate due to addition of delivery destinations or the like.

(First Operation Example of Information Processing Apparatus 100)

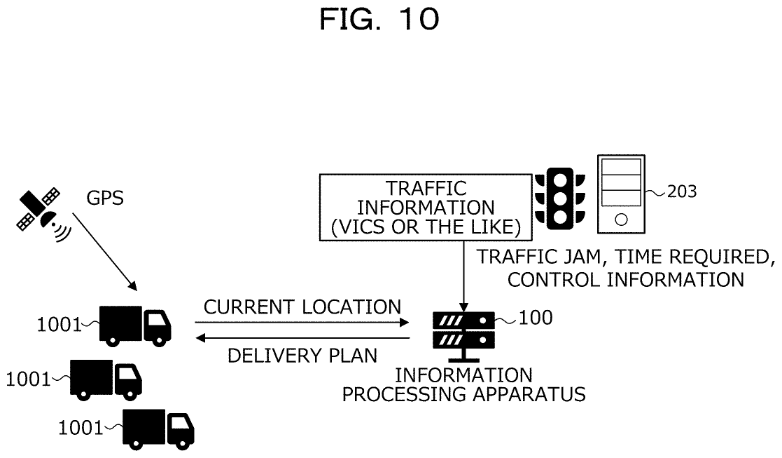

Next, a first operation example of the information processing apparatus 100 will be described with reference to FIGS. 10 to 15.

FIGS. 10 to 15 are explanatory diagrams illustrating a first operation example of the information processing apparatus 100. In FIG. 10, the information processing apparatus 100 draws up and adopts initial delivery plans by setting all of delivery destinations as determination targets for determining the visit plan, and determining an initial moving route of each delivery vehicle 1001. The information processing apparatus 100 draws up the initial delivery plan, for example, the day before the delivery operation.

The information processing apparatus 100 transmits the initial moving route of each delivery vehicle 1001 to the on-board apparatus 204 mounted on the delivery vehicle 1001. The delivery vehicle 1001 outputs the moving route such that the driver can grasp it. The driver drives the delivery vehicle 1001 and moves the delivery vehicle 1001 along the moving route to carry out the delivery operation.

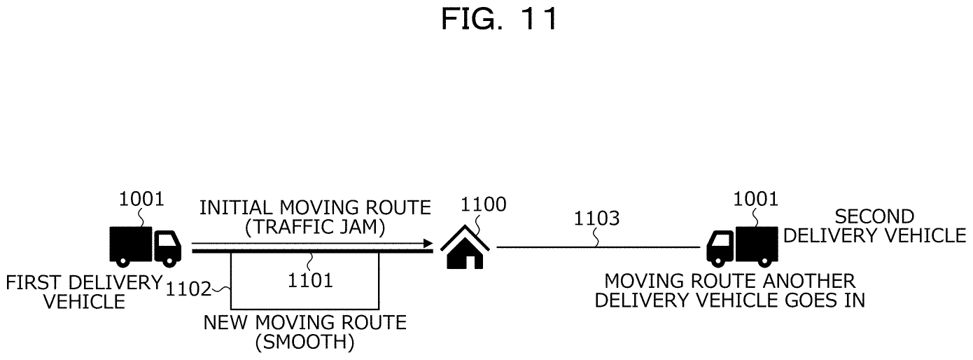

The delivery vehicle 1001 periodically transmits the progress information including the current location of the delivery vehicle 1001 and the visit history of the delivery vehicle 1001 to the information processing apparatus 100 during the movement. While each delivery vehicle 1001 is moving, the information processing apparatus 100 periodically receives the progress information including the current location of the delivery vehicle 1001 and the visit history of the delivery vehicle 1001 from each delivery vehicle 1001. Furthermore, the information processing apparatus 100 periodically receives the traffic information from the traffic management apparatus 203. The traffic information indicates, for example, a road condition. The road condition is, for example, occurrence of a traffic jam, occurrence of a traffic accident, start of road construction, start of street closure, or the like. Next, description will be moved onto FIG. 11.

In FIG. 11, the information processing apparatus 100 detects a trigger for changing the moving route of at least one delivery vehicle 1001 on the basis of the current location of each delivery vehicle 1001 and the traffic information. For example, the information processing apparatus 100 detects the determination that there is a moving route on which one delivery vehicle 1001 can arrive at the delivery destination 1100 earlier than the current moving route, as the trigger for changing the moving route of the delivery vehicle 1001.

Specifically, as illustrated in FIG. 11, the information processing apparatus 100 determines whether there is a moving route 1102 on which a first delivery vehicle 1001 can arrive at the delivery destination 1100 earlier than a current moving route 1101. The information processing apparatus 100 detects the determination that there is the moving route 1102 on which the first delivery vehicle 1001 can arrive at the delivery destination 1100 earlier, as the trigger for changing the moving route of the delivery vehicle 1001. Then, the information processing apparatus 100 sets the first delivery vehicle 1001 as the delivery vehicle to be processed.

Furthermore, for example, the information processing apparatus 100 determines whether it is more favorable that a certain delivery vehicle 1001 goes to the delivery destination 1100 than another delivery vehicle 1001 going to the delivery destination 1100. Specifically, the information processing apparatus 100 determines it is more favorable that a certain delivery vehicle 1001 goes to the delivery destination 1100 if the certain delivery vehicle 1001 goes to the delivery destination 1100 and can visit the delivery destination 1100 earlier than another delivery vehicle 1001 going to the delivery destination 1100. The information processing apparatus 100 detects the determination that it is more favorable that one delivery vehicle 1001 goes to the delivery destination 1100, as the trigger for changing the moving route of each delivery vehicle 1001.

Specifically, as illustrated in FIG. 11, the information processing apparatus 100 determines whether it is more favorable that a second delivery vehicle 1001 goes to the delivery destination 1100 on a moving route 1103 than the first delivery vehicle 1001 goes to the delivery destination 1100 on the moving route 1101. The information processing apparatus 100 determines it is possible to visit the delivery destination 1100 earlier by the second delivery vehicle 1001 going to the delivery destination 1100 on the moving route 1103 than the first delivery vehicle 1001 going to the delivery destination 1100 on the moving route 1101, and it is favorable. The information processing apparatus 100 detects the determination that it is more favorable that the second delivery vehicle 1001 goes to the delivery destination 1100 on the moving route 1103, as the trigger for changing the moving route of the first delivery vehicle 1001 and the moving route of the second delivery vehicle 1001. The information processing apparatus 100 sets the first delivery vehicle 1001 and the second delivery vehicle 1001 as delivery vehicles to be processed.

Furthermore, the information processing apparatus 100 detects the determination that, for example, there is an addition of the delivery destination 1100, a decrease in the delivery destination 1100, a change in the restriction on the delivery time zone regarding the delivery destination 1100, or the like, as the trigger for changing the moving route of each delivery vehicle 1001. Specifically, the information processing apparatus 100 determines whether there is an addition of the delivery destination 1100, a decrease in the delivery destination 1100, a change in the restriction on the delivery time zone, or the like, due to a redelivery request by a recipient corresponding to the delivery destination, or the like.

More specifically, the information processing apparatus 100 detects an addition of the delivery destination 1100 as the trigger for changing the moving route of the delivery vehicle 1001 closest to the delivery destination 1100, and sets the delivery vehicle 1001 as the delivery vehicle to be processed. More specifically, the information processing apparatus 100 may detect an addition of the delivery destination 1100 as the trigger for changing the moving route of the delivery vehicle 1001 carrying a package to be delivered to the delivery destination 1100, and set the delivery vehicle 1001 as the delivery vehicle to be processed. More specifically, the information processing apparatus 100 may detect an addition of the delivery destination 1100 as the trigger for changing the moving route of each delivery vehicle 1001 of a plurality of delivery vehicles 1001, and set the delivery vehicle 1001 as the delivery vehicle to be processed.

More specifically, the information processing apparatus 100 detects a deletion of the delivery destination 1100 as the trigger for changing the moving route of the delivery vehicle 1001 closest to the delivery destination 1100, and sets the delivery vehicle 1001 as the delivery vehicle to be processed. More specifically, the information processing apparatus 100 may detect a deletion of the delivery destination 1100 as the trigger for changing the moving route of the delivery vehicle 1001 carrying a package to be delivered to the delivery destination 1100, and set the delivery vehicle 1001 as the delivery vehicle to be processed. More specifically, the information processing apparatus 100 may detect a deletion of the delivery destination 1100 as the trigger for changing the moving route of each delivery vehicle 1001 of a plurality of delivery vehicles 1001, and set the delivery vehicle 1001 as the delivery vehicle to be processed.

More specifically, the information processing apparatus 100 detects a change in the restriction on the delivery time zone regarding the delivery destination 1100 as the trigger for changing the moving route of the delivery vehicle 1001 closest to the delivery destination 1100, and sets the delivery vehicle 1001 as the delivery vehicle to be processed. More specifically, the information processing apparatus 100 may detect a change in the restriction on the delivery time zone regarding the delivery destination 1100 as the trigger for changing the moving route of the delivery vehicle 1001 carrying a package to be delivered to the delivery destination 1100. Then, more specifically, the information processing apparatus 100 may set the delivery vehicle 1001 as the vehicle to be processed. More specifically, the information processing apparatus 100 may detect a change in the restriction on the delivery time zone regarding the delivery destination 1100 as the trigger for changing the moving route of each delivery vehicle 1001 of a plurality of delivery vehicles 1001, and set the delivery vehicle 1001 as the delivery vehicle to be processed.

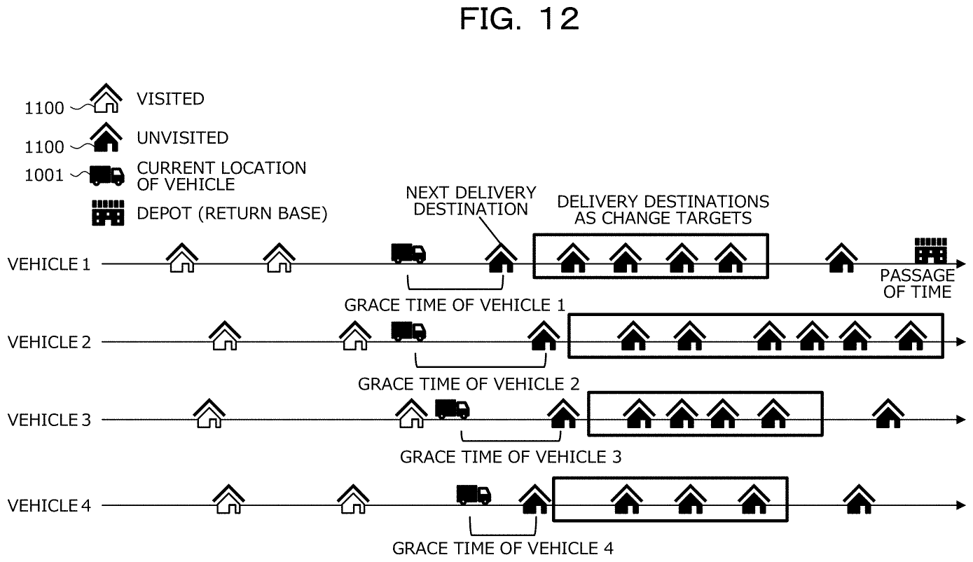

Furthermore, the information processing apparatus 100 determines, for example, whether a scheduled point of time when the delivery vehicle 1001 arrives at the delivery destination 1100 satisfies the restriction on the delivery time zone. The information processing apparatus 100 detects determination of not satisfying the restriction as the trigger for changing the moving route of the delivery vehicle 1001, and sets the delivery vehicle 1001 as the delivery vehicle to be processed. Here, it is assumed that the information processing apparatus 100 detects the trigger for changing the moving route of each delivery vehicle 1001 of the plurality of delivery vehicles 1001. Next, description will be moved onto FIG. 12.

In FIG. 12, each of the delivery vehicles 1001 is in motion. The delivery vehicles 1001 are, for example, a vehicle 1, a vehicle 2, a vehicle 3, and a vehicle 4. A plurality of delivery destinations 1100 planned to be visited by each delivery vehicle 1001 existing on the moving route of the delivery vehicle 1001 are illustrated on the time axis corresponding to the delivery vehicle 1001. In the example of FIG. 12, the white house marks indicate visited delivery destinations 1100 at the present moment. The black house marks indicate unvisited delivery destinations 1100 at the present moment.

The information processing apparatus 100 specifies the delivery destination 1100 planned to be visited later than the delivery destination 1100 planned to be visited next by each delivery vehicle 1001, as a candidate for the delivery destination 1100 as change target for changing the visit plan. In other words, the information processing apparatus 100 does not set each delivery destination 1100 from the first starting point of each delivery vehicle 1001 to the delivery destination 1100 planned to be visited next by the delivery vehicle 1001 as the delivery destination 1100 for changing the visit plan.

The information processing apparatus 100 calculates the remaining time to when each delivery vehicle 1001 departs, after visit, the delivery destination 1100 planned to be visited next, as the grace time for changing the moving route of the delivery vehicle 1001, on the basis of the average speed, the average staying time, and the like of the delivery vehicle 1001.

Thereby, even if the delivery vehicle 1001 continues to move and the delivery status continues to change, the information processing apparatus 100 can grasp by when the moving route of the delivery vehicle 1001 should be changed so as not to hinder the delivery operation after changing the moving route of the delivery vehicle 1001.

The information processing apparatus 100 further narrows down, for each delivery vehicle 1001, the specified candidates for the delivery destination 1100 so that the change in the moving route of the delivery vehicle 1001 is completed within the set grace time. For example, the information processing apparatus 100 further narrows down, for each delivery vehicle 1001, the specified candidates for the delivery destination 1100, so that the number of delivery destinations 1100 as change targets for changing the visit plan does not exceed the number of delivery destinations 1100 for which the visit plan is changeable within the set grace time. In the example of FIG. 12, the information processing apparatus 100 determines the delivery destinations 1100 surrounded by the square as the delivery destinations 1100 as change targets for actually changing the visit plan, and sets the delivery destinations as the change targets.

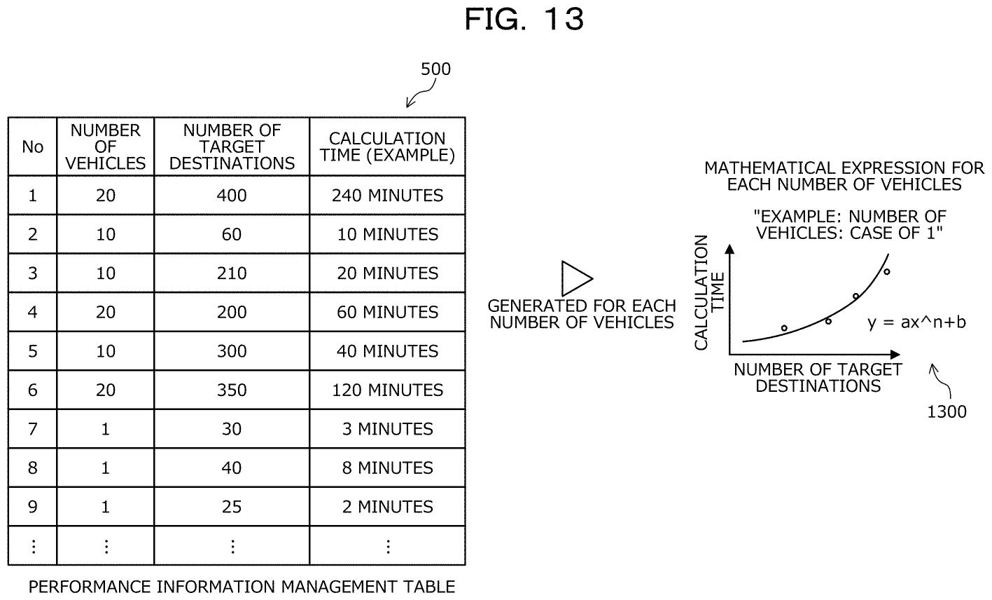

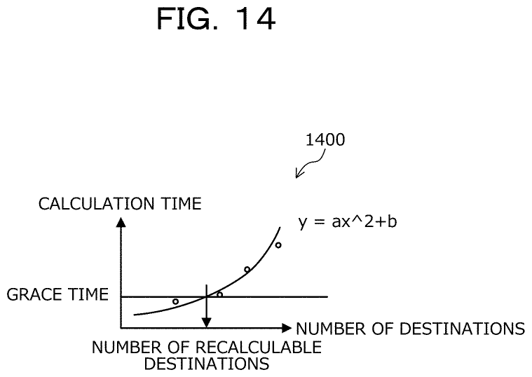

Next, moving onto the description of FIGS. 13 and 14, one example in which the information processing apparatus 100 actually determines the delivery destinations 1100 as change targets for changing the visit plan will be described. In FIG. 13, the information processing apparatus 100 refers to, for example, the performance information management table 500, and generates a mathematical expression 1300 indicating the relationship between the number of target destinations and the calculation time for each number of vehicles. The mathematical expression is, for example, y=ax\hat{ }n+b. y is the calculation time. x is the number of target destinations. a is a coefficient. b is a coefficient. The information processing apparatus 100 may generate the mathematical expression 1300 in advance. At this time, if the performance information management table 500 is empty, for example, the information processing apparatus 100 may provisionally calculate the calculation time and generate the mathematical expression 1300 in advance by assuming the number of vehicles and the number of target destinations and by changing a provisional moving route. Next, description will be moved onto FIG. 14.

In FIG. 14, the information processing apparatus 100 acquires a mathematical expression 1400 for the number of vehicles: 1. For each delivery vehicle 1001, the information processing apparatus 100 inputs the grace time calculated for the delivery vehicle 1001 to y of the mathematical expression 1400, and calculates the number=x of delivery destinations 1100 for which the visit plan by the delivery vehicle 1001 is changeable. For each delivery vehicle 1001, the information processing apparatus 100 selects the calculated number x of candidates for the delivery destination 1100 from the beginning of the candidates for the delivery destination 1100 specified for the delivery vehicle 1001. For each delivery vehicle 1001, the information processing apparatus 100 determines the selected candidates for the delivery destination 1100 as the delivery destinations 1100 as change targets for changing the visit plan by the delivery vehicle 1001 and sets the determined delivery destinations as the change targets. Thereby, the information processing apparatus 100 can determine the delivery destinations 1100 as change targets for changing the visit plan within a range not to hinder the delivery operation, and appropriately enables redrawing up of the delivery plan.

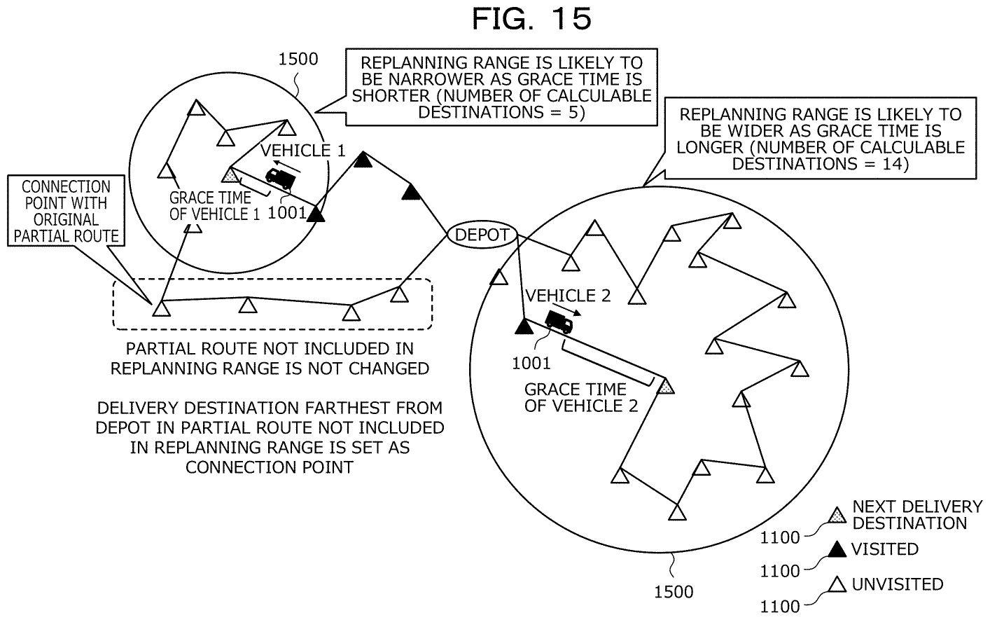

Next, moving onto the description of FIG. 15, a specific example in which the information processing apparatus 100 actually determines the delivery destinations 1100 for changing the visit plan will be described. In FIG. 15, (15-1) the information processing apparatus 100 sets, for each delivery vehicle 1001, an area 1500 centered on the delivery destination 1100 planned to be visited next by the delivery vehicle 1001. The area 1500 is, for example, a range from the center to a fixed distance, and is a circular area. The area 1500 may be, for example, a movable range from the center in a fixed time.

(15-2) The information processing apparatus 100 determines, for each delivery vehicle 1001, whether the number of unvisited delivery destinations 1100 included in the area 1500 set for the delivery vehicle 1001 is equal to or larger than the calculated number of delivery destinations 1100 for which the visit plan is changeable.

Here, the information processing apparatus 100 expands, for a certain delivery vehicle 1001, the area 1500 set for the delivery vehicle 1001 by a predetermined width when the number is not equal to or larger than the number of delivery destinations 1100 for which the visit plan is changeable. Then, the information processing apparatus 100 determines again, each time expanding the area 1500, for a certain delivery vehicle 1001, whether the number of unvisited delivery destinations 1100 included in the area 1500 is equal to or larger than the calculated number of delivery destinations 1100 for which the visit plan is changeable.

Meanwhile, the information processing apparatus 100 sets, for a certain delivery vehicle 1001, the area 1500 set for the delivery vehicle 1001 as a replanning range, when the number is not equal to or larger than the number of delivery destinations 1100 for which the visit plan is changeable. For each delivery vehicle 1001, the information processing apparatus 100 leaves a partial route not included in the replanning range set for the delivery vehicle 1001 without change, of the moving route of the delivery vehicle 1001. In the example of FIG. 15, the partial route not included in the replanning range is surrounded by the broken line. For example, the information processing apparatus 100 leaves the partial route not included in the replanning range without change by not changing the visit plan, for the unvisited delivery destinations 1100 not included in the replanning range.

Meanwhile, for each delivery vehicle 1001, the information processing apparatus 100 changes a partial route included in the replanning range set for the delivery vehicle 1001, of the moving route of the delivery vehicle 1001. For each delivery vehicle 1001, for example, the information processing apparatus 100 selects the undelivered delivery destinations 1100 by the calculated number of delivery destinations 1100 for which the visit plan is changeable, from among the undelivered delivery destinations 1100 not included in the replanning range set for the delivery vehicle 1001. The information processing apparatus 100 sets, for example, the selected delivery destination 1100 as the change target for actually changing the delivery schedule.

Then, for each delivery vehicle 1001, for example, the information processing apparatus 100 changes the delivery schedule of the undelivered delivery destination 1100 set for the delivery vehicle 1001. Thereby, the information processing apparatus 100 changes, for each delivery vehicle 1001, the partial route included in the replanning range set for the delivery vehicle 1001, and changes the moving route of the delivery vehicle 1001. In this way, for each delivery vehicle 1001, the information processing apparatus 100 redraws up and adopts the delivery plan as a whole by changing the moving route of the delivery vehicle 1001.

At this time, specifically, for each delivery vehicle 1001, the information processing apparatus 100 sets the delivery destination 1100 farthest from the depot as the final arrival point, in the partial route not included in the replanning range set for the delivery vehicle 1001, as a connection point. Specifically, for each delivery vehicle 1001, the information processing apparatus 100 changes the partial route included in the replanning range so as to be connected with the partial route not included in the replanning range set for the delivery vehicle 1001 at the set connection point.

As a result, the information processing apparatus 100 can prevent the moving route of each delivery vehicle 1001 from being disconnected. Furthermore, even if the delivery vehicle 1001 continues to move and the delivery status continues to change, the information processing apparatus 100 can appropriately redraw up the delivery plan so as not to hinder the delivery operation and can determine the effective moving route of each delivery vehicle 1001.

As illustrated in FIG. 15, the longer the grace time, the wider the replanning range and the larger the number of delivery destinations 1100 for which the visit plan is changeable. The shorter the grace time, the narrower the replanning range and the smaller the number of delivery destinations 1100 for which the visit plan is changeable. Therefore, the moving route of the delivery vehicle 1001 is likely to be significantly changed as the grace time is longer. The information processing apparatus 100 can change the moving route of each delivery vehicle 1001 within an appropriate range that differs for each delivery vehicle 1001, and can efficiently redraw up the delivery plan as a whole.

Here, for each delivery vehicle 1001, the information processing apparatus 100 may keep the moving route of the delivery vehicle 1001 unchanged if the moving route of the delivery vehicle 1001 has not been changed by the time the grace time actually elapses. Thereby, the information processing apparatus 100 can appropriately perform the delivery work.

Furthermore, for each delivery vehicle 1001, the information processing apparatus 100 may return the moving route of the delivery vehicle 1001 to the state before change if the changed moving route of the delivery vehicle 1001 does not satisfy a predetermined restriction. The predetermined restriction is that, for example, the delivery vehicle 1001 visits each delivery destination 1100 within the same day. At this time, the information processing apparatus 100 may postpone the delivery schedule for any of the delivery destinations 1100 to the next day or later and rechange the moving route. Thereby, the information processing apparatus 100 can appropriately perform the delivery work.

Furthermore, for each delivery vehicle 1001, the information processing apparatus 100 may determine whether the moving route after change is more appropriate than the moving route before change, and actually change the moving route in a case of determining that the change is appropriate. For example, if the delivery cost in the moving route after change is smaller than the delivery cost in the moving route before change, the information processing apparatus 100 determines that the moving route after change is more appropriate than the moving route before change. Thereby, the information processing apparatus 100 can adopt an appropriate delivery plan and can reduce the delivery cost.

Here, the case in which the information processing apparatus 100 sets the remaining time to when the delivery vehicle 1001 departs, after visit, the delivery destination 1100 planned to be visited next, as the grace time, has been described. However, the embodiment is not limited to the case. For example, there may be a case where the information processing apparatus 100 sets the remaining time to when the delivery vehicle 1001 departs, after visit, the delivery destination 1100 planned to be visited by the delivery vehicle 1001 n points later, as the grace time.

Specifically, the information processing apparatus 100 determines whether the remaining time to when the delivery vehicle 1001 departs, after visit, the delivery destination 1100 planned to be visited next, is equal to or less than a threshold value. Then, when determining that the remaining time is equal to or less than the threshold value, the information processing apparatus 100 sets the remaining time to when the delivery vehicle 1001 departs, after visit, the delivery destination 1100 planned to be visited n points later, as the grace time. As a result, the information processing apparatus 100 can have a relatively long grace time, and can easily change the moving route of the delivery vehicle 1001.

Specifically, the information processing apparatus 100 determines whether the number of delivery destinations 1100 for which the visit plan becomes changeable in a case of assuming that the remaining time to when the delivery vehicle 1001 departs, after visit, the delivery destination 1100 planned to be visited next as the grace time, is equal to or less than a threshold value. The threshold value is, for example, 0. Then, when determining that the remaining time is equal to or less than the threshold value, the information processing apparatus 100 sets the remaining time to when the delivery vehicle 1001 departs, after visit, the delivery destination 1100 planned to be visited n points later, as the grace time. Thereby, the information processing apparatus 100 can have a relatively long grace time and can easily redraw up the delivery plan.

Furthermore, for example, when calculating the remaining time to when each delivery vehicle 1001 departs, after visit, the delivery destination 1100 planned to be visited n points later, the information processing apparatus 100 may variably set the n for each delivery vehicle 1001.

Here, the case in which the information processing apparatus 100 changes the moving route of each delivery vehicle 1001 to be processed has been described, but the present embodiment is not limited to the case. For example, there may be case in which the information processing apparatus 100 causes each different another computer to change the moving route of each delivery vehicle 1001 to be processed. The another computer is, for example, the arithmetic unit 201. The another computer may be, for example, the on-board apparatus 204.

Specifically, it is conceivable that, if the information processing apparatus 100 changes the moving routes of the respective delivery vehicles 1001 to be processed at the same time, the change of the moving routes of the delivery vehicles 1001 may not be completed within the estimated time required. In this case, the information processing apparatus 100 causes each different another computer to change the moving route of each delivery vehicle 1001 to be processed.

(Overall Processing Procedure in First Operation Example)

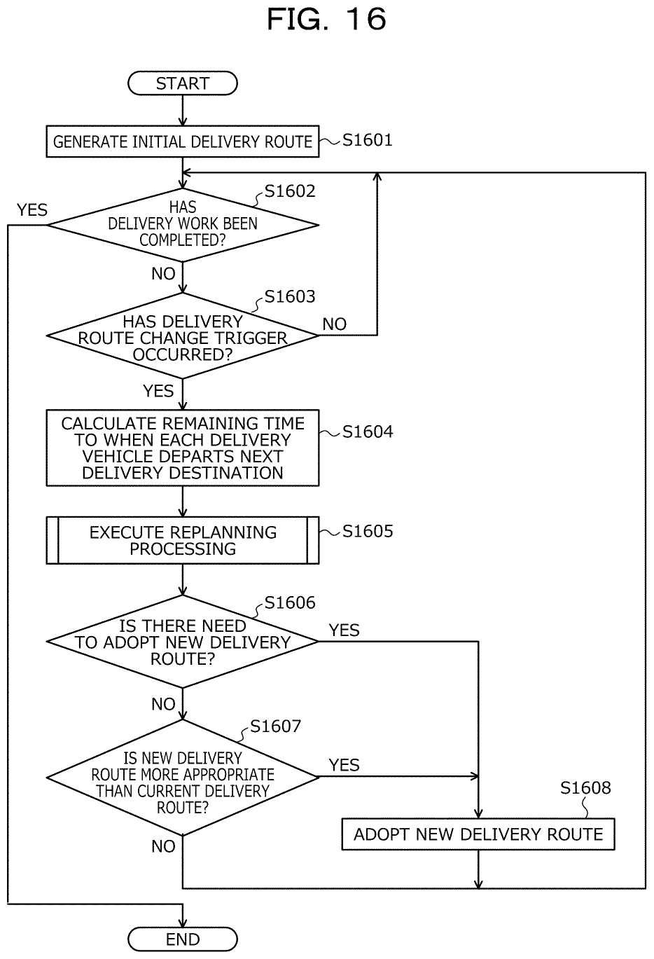

Next, one example of an overall processing procedure in the first operation example executed by the information processing apparatus 100 will be described with reference to FIG. 16. The overall processing is implemented by, for example, the CPU 401 illustrated in FIG. 4, the storage area such as the memory 402 or the recording medium 405, and the network I/F 403.

FIG. 16 is a flowchart illustrating one example of an overall processing procedure in the first operation example. In FIG. 16, the information processing apparatus 100 generates an initial delivery route for each delivery vehicle 1001 and adopts the generated delivery route for each delivery vehicle 1001 (step S1601). Here, the information processing apparatus 100 transmits the adopted delivery route for each delivery vehicle 1001 to the on-board apparatus 204 of the delivery vehicle 1001.

Next, the information processing apparatus 100 determines whether the delivery work has been completed (step S1602). Here, in a case where the delivery work has been completed (step S1602: Yes), the information processing apparatus 100 terminates the overall processing. On the other hand, in a case where the delivery work has not been completed (step S1602: No), the information processing apparatus 100 proceeds to the processing of step S1603.

In step S1603, the information processing apparatus 100 determines whether the change trigger has occurred, which is an event to change the delivery route being adopted for at least one of the delivery vehicles 1001 (step S1603). Herein, in a case where the change trigger has not occurred (step S1603: No), the information processing apparatus 100 returns to the processing of step S1602. On the other hand, in a case where the change trigger has occurred (step S1603: Yes), the information processing apparatus 100 sets each delivery vehicle 1001 for which the change trigger has occurred as the delivery vehicle to be processed, and proceeds to the processing of step S1604.

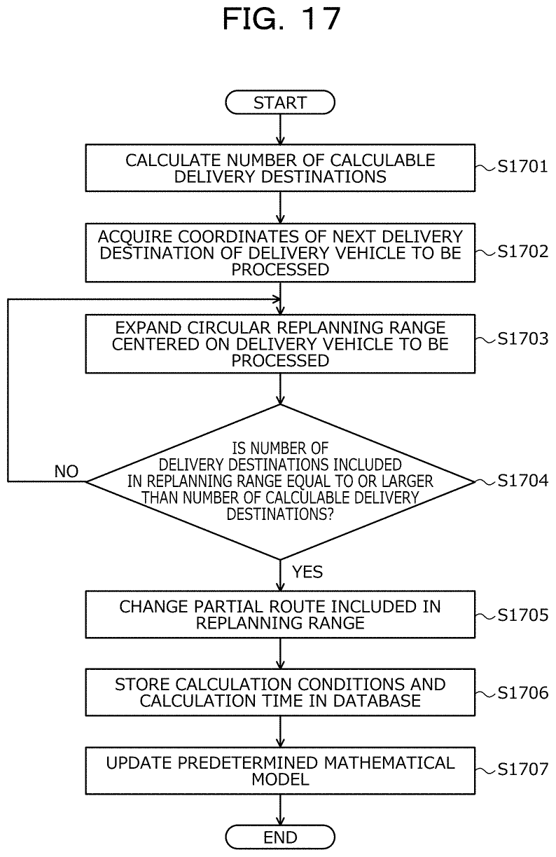

In step S1604, the information processing apparatus 100 calculates the remaining time to when each delivery vehicle 1001 to be processed departs the next delivery destination 1100, and sets the remaining time as the grace time (step S1604). For example, the information processing apparatus 100 calculates the remaining time to when each delivery vehicle 1001 to be processed departs the next delivery destination 1100 on the basis of the average speed of each delivery vehicle 1001 to be processed and the road condition. Then, for each delivery vehicle 1001 to be processed, the information processing apparatus 100 executes replanning processing to be described below in FIG. 17 to generate a new delivery route for each delivery vehicle 1001 to be processed (step S1605).

Next, the information processing apparatus 100 determines whether there is a need to adopt the generated new delivery route for each delivery vehicle 1001 to be processed (step S1606). Here, in a case where there is no need for adoption (step S1606: No), the information processing apparatus 100 proceeds to the processing of step S1607. On the other hand, in a case where there is a need for adoption (step S1606: Yes), the information processing apparatus 100 proceeds to the processing of step S1608.

In step S1607, the information processing apparatus 100 determines whether at least the generated new delivery route for one delivery vehicle 1001 to be processed is more appropriate than the current delivery route (step S1607). Here, in a case where the generated new delivery route is not more appropriate than the current delivery route (step S1607: No), the information processing apparatus 100 returns to the processing of step S1602. On the other hand, in a case where the generated new delivery route is more appropriate than the current delivery route (step S1607: Yes), the information processing apparatus 100 proceeds to the processing of step S1608.

In step S1608, the information processing apparatus 100 adopts a new delivery route for one delivery vehicle 1001 that has been determined to be more appropriate than the current delivery route (step S1608). Here, the information processing apparatus 100 transmits the adopted new delivery route for one delivery vehicle 1001 to the on-board apparatus 204 of the delivery vehicle 1001. Then, the information processing apparatus 100 returns to the processing of step S1602.

(Replanning Processing Procedure in First Operation Example)

Next, one example of a replanning processing procedure in the first operation example executed by the information processing apparatus 100 will be described with reference to FIG. 17. The replanning processing is implemented by, for example, the CPU 401, the storage area such as the memory 402 or the recording medium 405, and the network I/F 403 illustrated in FIG. 4.

FIG. 17 is a flowchart illustrating one example of the replanning processing procedure in the first operation example. In FIG. 17, the information processing apparatus 100 calculates the number of calculable delivery destinations 1100 by inputting the grace time set for the delivery vehicle 1001 to be processed into a predetermined mathematical model (step S1701).

Next, the information processing apparatus 100 acquires the coordinates of the next delivery destination 1100 of the delivery vehicle 1001 to be processed (step S1702). Then, the information processing apparatus 100 expands a circular replanning range centered on the delivery vehicle 1001 to be processed (step S1703).

Next, the information processing apparatus 100 determines, for the delivery vehicle 1001 to be processed, whether the number of delivery destinations 1100 included in the replanning range is equal to or larger than the number of calculatable delivery destinations 1100 (step S1704). Here, in a case where the number of delivery destinations is less than the number of calculable delivery destinations 1100 (step S1704: No), the information processing apparatus 100 returns to the processing of step S1703. On the other hand, in a case where the number of delivery destinations is equal to or larger than the number of calculable delivery destinations 1100 (step S1704: Yes), the information processing apparatus 100 returns to the processing of step S1705.

In step S1705, the information processing apparatus 100 changes the partial route included in the replanning range while maintaining the partial route off the replanning range in the delivery route for the delivery vehicle 1001 to be processed (step S1705).

Next, the information processing apparatus 100 stores calculation conditions and the calculation time in a database (step S1706). Then, the information processing apparatus 100 updates the predetermined mathematical model (step S1707). Thereafter, the information processing apparatus 100 terminates the replanning processing.

Here, the information processing apparatus 100 may swap some steps in the processing order in each of the flowcharts in FIGS. 16 and 17 and execute the processing. For example, steps S1606 and S1607 may be swapped in the processing order. Furthermore, the information processing apparatus 100 may omit the processing in some steps in each of the flowcharts in FIGS. 16 and 17. For example, the processing of steps S1606 and S1607 can be omitted.

(Second Operation Example of Information Processing Apparatus 100)

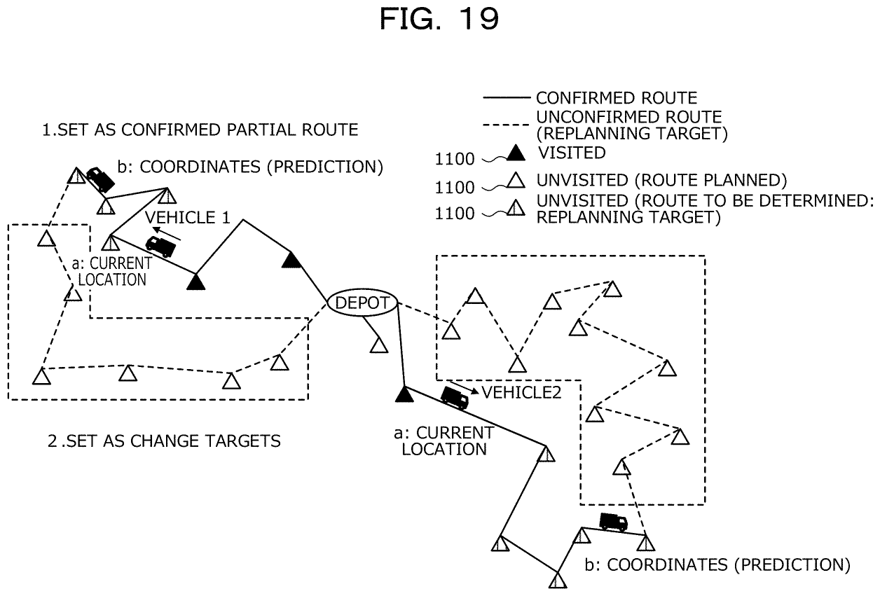

Next, a second operation example of the information processing apparatus 100 will be described with reference to FIGS. 18 and 19.

FIGS. 18 and 19 are explanatory diagrams illustrating a second operation example of the information processing apparatus 100. Similar to the first operation example, the information processing apparatus 100 draws up and adopts the initial delivery plan by setting all of delivery destinations as destinations planned to be visited and determining the initial moving route of each delivery vehicle 1001. Similar to the first operation example, the information processing apparatus 100 transmits the initial moving route of each delivery vehicle 1001 to the on-board apparatus 204 mounted on the delivery vehicle 1001.

Similar to the first operation example, while each delivery vehicle 1001 is moving, the information processing apparatus 100 periodically receives the progress information including the current location of the delivery vehicle 1001 and the visit history of the delivery vehicle 1001 from each delivery vehicle 1001. Similar to the first operation example, the information processing apparatus 100 periodically receives the traffic information from the traffic management apparatus 203. Similar to the first operation example, the information processing apparatus 100 detects a trigger for changing the moving route of at least one delivery vehicle 1001 on the basis of the current location of each delivery vehicle 1001 and the traffic information.

In FIG. 18, each of the delivery vehicles 1001 is in motion. The delivery vehicle 1001 is, for example, the vehicle 1 or the like. It is assumed that the information processing apparatus 100 has detected at least the trigger for changing the moving route of the vehicle 1, and has set the vehicle 1 as the vehicle to be processed. The plurality of delivery destinations 1100 planned to be visited by the vehicle 1 existing on the moving route of the vehicle 1 are illustrated on the time axis corresponding to the vehicle 1. In the example of FIG. 18 of the vehicle 1, the white house marks indicate visited delivery destinations at the present moment. The black house marks indicate unvisited delivery destinations at the present moment.

(18-1) The information processing apparatus 100 assumes that the delivery destinations 1100 unvisited by the vehicle 1 to be processed are set as the delivery destinations 1100 for changing the visit plan, and estimates the time required for changing the moving route of the vehicle 1. In the example of FIG. 18, specifically, the information processing apparatus 100 assumes that the delivery destinations 1100 included in a range 1801 are set as the delivery destinations 1100 for changing the visit plan The information processing apparatus 100 estimates the time required for changing the moving route of the vehicle 1 by using, for example, the mathematical expression 1300 illustrated in FIG. 13. Specifically, the information processing apparatus 100 calculates the time required=y by substituting the set number=x of delivery destinations 1100 into the mathematical expression 1300 illustrated in FIG. 13.

(18-2) The information processing apparatus 100 estimates the coordinates of the vehicle 1, assuming that the calculated time required has elapsed. In the case of assuming that the calculated time required has elapsed on the basis of the estimated coordinates of vehicle 1, the information processing apparatus 100 specifies the visited delivery destination 1100 and the delivery destination 1100 planned to be visited next by the vehicle 1.

Thereby, assuming that the change of the moving route of the vehicle 1 is started from the present moment, the information processing apparatus 100 can specify the delivery destination 1100 visited by the vehicle 1 and the delivery destination 1100 planned to be visited next by the vehicle 1 when the change is completed. In other words, the information processing apparatus 100 can specify the destination that is not useful as a destination for changing the visit plan and is more favorable not to be a destination for changing the visit plan.

(18-3) The information processing apparatus 100 determines the destinations unvisited by the vehicle 1, other than the specified destinations, as the delivery destinations 1100 as change targets for changing the visit plan when changing the moving route of the vehicle 1. In the example of FIG. 18, specifically, the information processing apparatus 100 determines the delivery destinations 1100 included in a range 1802 as the delivery destinations 1100 as change targets for changing the visit plan when changing the moving route of the vehicle 1.

Thereby, even if the delivery vehicle 1001 continues to move and the delivery status continues to change, the information processing apparatus 100 enables the moving route of the delivery vehicle 1001 to be changed within the range not to hinder the delivery operation, and enables the delivery plan to be redrawn up. Next, moving onto the description of FIG. 19, a specific example in which the information processing apparatus 100 determines the delivery destinations 1100 as change targets for changing the visit plan will be described.

In FIG. 19, it is assumed that the information processing apparatus 100 sets the vehicle 1 and the vehicle 2 as the vehicles to be processed. The information processing apparatus 100 acquires a current location a of the vehicle 1. The information processing apparatus 100 assumes that the delivery destinations 1100 unvisited by the vehicle 1 are set as the delivery destinations 1100 for changing the visit plan, and estimates the time required for changing the moving route of the vehicle 1. The information processing apparatus 100 specifies coordinates b of the vehicle 1 after the estimated time required has elapsed, on the basis of the average speed and the average staying time of the vehicle 1.

(19-1) The information processing apparatus 100 specifies the delivery destination 1100 planned to be visited next by the vehicle 1 after the time required has elapsed, on the basis of the coordinates b of the vehicle 1. Then, the information processing apparatus 100 sets a partial route from the first starting point of the vehicle 1 to the specified delivery destination 1100 planned to be visited next by the vehicle 1, of the moving route of the vehicle 1, as a confirmed partial route, and leaves the confirmed partial route without change. The first starting point is, for example, a depot. In the example of FIG. 19, the confirmed partial routes are illustrated by the solid lines. For example, the information processing apparatus 100 leaves the confirmed partial route without change by not changing the visit plan of the unvisited delivery destination 1100 on the confirmed partial route.

(19-2) The information processing apparatus 100 sets a partial route after the specified delivery destination 1100 planned to be visited next by the vehicle 1, of the moving route of the vehicle 1, as a change target. For example, the information processing apparatus 100 changes the partial route as change target by changing the visit plan of the unvisited delivery destination 1100 on the partial route as change target, to change the moving route of the vehicle 1.

Similarly, the information processing apparatus 100 acquires the current location a of the vehicle 2. The information processing apparatus 100 assumes that the delivery destinations 1100 unvisited by the vehicle 2 are set as the delivery destinations 1100 for changing the visit plan, and estimates the time required for changing the moving route of the vehicle 2. The information processing apparatus 100 specifies coordinates b of the vehicle 2 after the estimated time required has elapsed, on the basis of the average speed and the average staying time of the vehicle 2.

The information processing apparatus 100 specifies the delivery destination 1100 planned to be visited next by the vehicle 2 after the time required has elapsed, on the basis of the coordinates b of the vehicle 2. Then, the information processing apparatus 100 sets a partial route from the first starting point of the vehicle 2 to the specified delivery destination 1100 planned to be visited next by the vehicle 2, of the moving route of the vehicle 2, as a confirmed partial route, and leaves the confirmed partial route without change. The first starting point is, for example, a depot. In the example of FIG. 19, the confirmed partial routes are illustrated by the solid lines. For example, the information processing apparatus 100 leaves the confirmed partial route without change by not changing the visit plan of the unvisited delivery destination 1100 on the confirmed partial route.

The information processing apparatus 100 sets a partial route after the specified delivery destination 1100 planned to be visited next by the vehicle 2, of the moving route of the vehicle 2, as a change target. In the example of FIG. 19, the partial routes as change targets are illustrated by the broken lines. For example, the information processing apparatus 100 changes the partial route as change target by changing the visit plan of the unvisited delivery destination 1100 on the partial route as change target, to change the moving route of the vehicle 2. Thereby, even if the delivery vehicle 1001 continues to move and the delivery status continues to change, the information processing apparatus 100 can appropriately redraw up the delivery plan so as not to hinder the delivery operation and can determine the effective moving route of each delivery vehicle 1001.

Here, the information processing apparatus 100 may determine whether the moving route after change is more appropriate than the moving route before change, and actually change the moving route in a case of determining that the change is appropriate. For example, if the delivery cost in the moving route after change is smaller than the delivery cost in the moving route before change, the information processing apparatus 100 determines that the moving route after change is more appropriate than the moving route before change. Thereby, the information processing apparatus 100 can adopt an appropriate moving route and can reduce the delivery cost.

(Overall Processing Procedure in Second Operation Example)

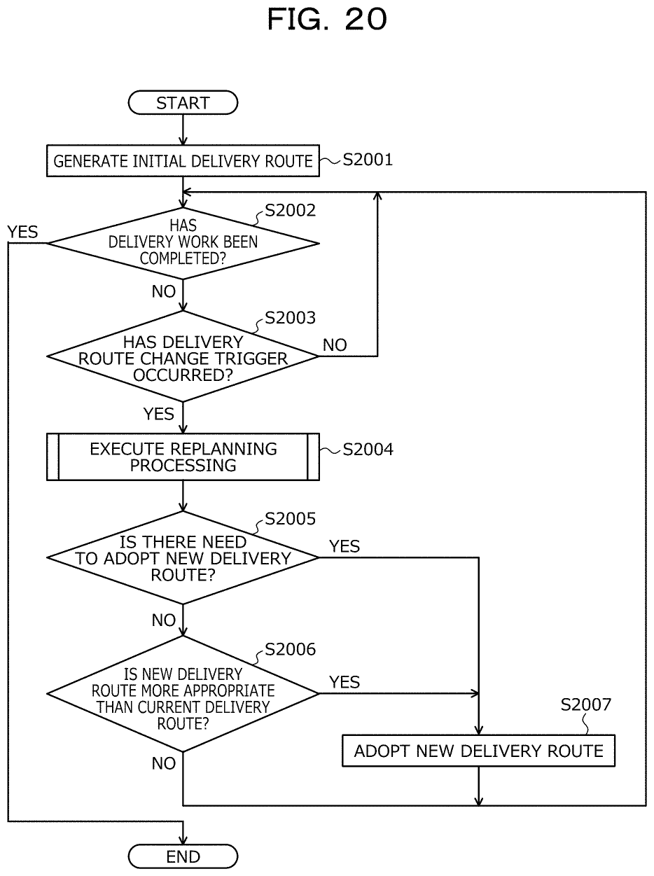

Next, one example of an overall processing procedure in the second operation example executed by the information processing apparatus 100 will be described with reference to FIG. 20. The overall processing is implemented by, for example, the CPU 401 illustrated in FIG. 4, the storage area such as the memory 402 or the recording medium 405, and the network I/F 403.

FIG. 20 is a flowchart illustrating one example of an overall processing procedure in the second operation example. In FIG. 20, the information processing apparatus 100 generates an initial delivery route for each delivery vehicle 1001 and adopts the generated delivery route for each delivery vehicle 1001 (step S2001). Here, the information processing apparatus 100 transmits the adopted delivery route for each delivery vehicle 1001 to the on-board apparatus 204 of the delivery vehicle 1001.

Next, the information processing apparatus 100 determines whether the delivery work has been completed (step S2002). Here, in a case where the delivery work has been completed (step S2002: Yes), the information processing apparatus 100 terminates the overall processing. On the other hand, in a case where the delivery work has not been completed (step S2002: No), the information processing apparatus 100 proceeds to the processing of step S2003.

In step S2003, the information processing apparatus 100 determines whether the change trigger of the delivery route being adopted for at least one of the delivery vehicles 1001 has occurred (step S2003). Herein, in a case where the change trigger has not occurred (step S2003: No), the information processing apparatus 100 returns to the processing of step S2002. On the other hand, in a case where the change trigger has occurred (step S2003: Yes), the information processing apparatus 100 sets each delivery vehicle 1001 for which the change trigger has occurred as the delivery vehicle to be processed, and proceeds to the processing of step S2004.

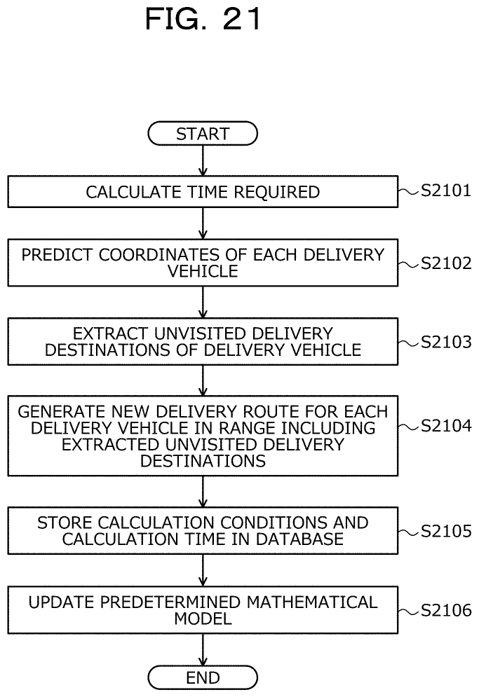

In step S2004, for each delivery vehicle 1001 to be processed, the information processing apparatus 100 executes replanning processing to be described below in FIG. 21 to generate a new delivery route for each delivery vehicle 1001 to be processed (step S2004).

Next, the information processing apparatus 100 determines whether there is a need to adopt the generated new delivery route for each delivery vehicle 1001 to be processed (step S2005). Here, in a case where there is no need for adoption (step S2005: No), the information processing apparatus 100 proceeds to the processing of step S2006. On the other hand, in a case where there is a need for adoption (step S2005: Yes), the information processing apparatus 100 proceeds to the processing of step S2007.

In step S2006 the information processing apparatus 100 determines whether at least the generated new delivery route for each delivery vehicle 1001 to be processed is more appropriate than the current delivery route (step S2006). Here, in a case where the generated new delivery route is not more appropriate than the current delivery route (step S2006: No), the information processing apparatus 100 returns to the processing of step S2002. On the other hand, in a case where the generated new delivery route is more appropriate than the current delivery route (step S2006: Yes), the information processing apparatus 100 proceeds to the processing of step S2007.

In step S2007, the information processing apparatus 100 adopts a new delivery route for one delivery vehicle 1001 that has been determined to be more appropriate than the current delivery route (step S2007). Here, the information processing apparatus 100 transmits the adopted new delivery route for one delivery vehicle 1001 to the on-board apparatus 204 of the delivery vehicle 1001. Then, the information processing apparatus 100 returns to the processing of step S2002.

(Replanning Processing Procedure in Second Operation Example)

Next, one example of a replanning processing procedure in the second operation example executed by the information processing apparatus 100 will be described with reference to FIG. 21. The replanning processing is implemented by, for example, the CPU 401, the storage area such as the memory 402 or the recording medium 405, and the network I/F 403 illustrated in FIG. 4.

FIG. 21 is a flowchart illustrating one example of the replanning processing procedure in the second operation example. In FIG. 21, for the delivery vehicle 1001 to be processed, the information processing apparatus 100 calculates the time required on the basis of the number of delivery destinations 1100 unvisited by the delivery vehicle 1001 to be processed, using a predetermined mathematical model (step S2101).

Next, the information processing apparatus 100 predicts the coordinates of the delivery vehicle 1001 to be processed of a case where the time required is assumed to have elapsed (step S2102). Then, the information processing apparatus 100 extracts the unvisited delivery destination 1100 by the delivery vehicle 1001 to be processed of the case where the time required is assumed to have elapsed on the basis of the predicted coordinates of the delivery vehicle 1001 (step S2103).

Next, the information processing apparatus 100 generates a new delivery route for the delivery vehicle 1001 to be processed within the range including the extracted unvisited delivery destinations 1100 (step S2104). Then, the information processing apparatus 100 stores calculation conditions and the calculation time in a database (step S2105).

Next, the information processing apparatus 100 updates the predetermined mathematical model (step S2106). Then, the information processing apparatus 100 terminates the replanning processing.

Here, the information processing apparatus 100 may swap some steps in the processing order in each of the flowcharts in FIGS. 20 and 21 and execute the processing. For example, steps S2006 and S2007 may be swapped in the processing order. Furthermore, the information processing apparatus 100 may omit the processing in some steps in each of the flowcharts in FIGS. 20 and 21. For example, the processing of steps S2006 and S2007 can be omitted.

As described above, according to the information processing apparatus 100, it is possible to detect to change the moving route that passes through a plurality of destinations planned to be visited by the mobile body. According to the information processing apparatus 100, when detecting to change the moving route of the mobile body, it is possible to acquire the remaining time to when the mobile body visits one unvisited destination or the remaining time to when the mobile body departs, after visit, one destination unvisited by the mobile body, among a plurality of destinations. According to the information processing apparatus 100, it is possible to determine the destinations as change targets for changing the visit plan, among the destinations unvisited by the mobile body included in the plurality of destinations, on the basis of the acquired remaining time. According to the information processing apparatus 100, it is possible to change the moving route of the mobile body on the basis of the determined destinations. Thereby, the information processing apparatus 100 can prevent the changed moving route from not matching the moving status of the mobile body and becoming an ineffective moving route.

According to the information processing apparatus 100, it is possible to specify the number of destinations for which the visit plan is changeable in the acquired remaining time, among the plurality of destinations, using a predetermined model. According to the information processing apparatus 100, it is possible to determine the destinations as change targets for changing the visit plan, among the destinations unvisited by the mobile body included in the plurality of destinations, on the basis of the specified number. As a result, the information processing apparatus 100 can accurately and easily specify the number of destinations for which the visit plan is changeable in the remaining time.

According to the information processing apparatus 100, it is possible to select the specified number of unvisited destinations included in the area with the destination planned to be visited next by the mobile body as the reference point, among the destinations unvisited by the mobile body included in the plurality of destinations, and determine the selected destinations as the destinations as change targets for changing the visit plan. Thereby, the information processing apparatus 100 can easily complete the change in the visit plan for the destination in the remaining time.

According to the information processing apparatus 100, it is possible to select the specified number of unvisited destinations included in the area with the starting point of one mobile body as the reference point, among the destinations unvisited by the mobile body included in the plurality of destinations, and determine the selected destinations as the destinations as change targets for changing the visit plan. Thereby, the information processing apparatus 100 can easily complete the change in the visit plan for the destination in the remaining time.

According to the information processing apparatus 100, it is possible to set the area on the basis of the linear distance from the reference point. Thereby, the information processing apparatus 100 enables determination of the destination for changing the visit plan so that the changed moving route is likely to be shortened in consideration of the linear distance from the reference point.

According to the information processing apparatus 100, it is possible to set the area on the basis of the travel time from the reference point. Thereby, the information processing apparatus 100 enables determination of the destination for changing the visit plan so that the changed moving route is likely to be shortened in consideration of the travel time from the reference point.

According to the information processing apparatus, it is possible to acquire the remaining time to when the mobile body visits the destination planned to be visited next or the remaining time to when the mobile body departs, after visit, the destination, among a plurality of destinations unvisited by the mobile body included in the plurality of destinations. Thereby, the information processing apparatus 100 can change the moving route of each mobile body before each mobile body visits, or departs, after visit, the destination planned to be visited next.

According to the information processing apparatus 100, when detecting to change the moving route of the mobile body, it is possible to acquire the time required for changing the moving route of the mobile body on the basis of the destinations unvisited by the mobile body among the plurality of destinations. According to the information processing apparatus 100, it is possible to determine the destinations as change targets for changing the visit plan, among the destinations unvisited by the mobile body included in the plurality of destinations, on the basis of the acquired time required. According to the information processing apparatus 100, it is possible to change the moving route of the mobile body on the basis of the determined destinations. Thereby, the information processing apparatus 100 can prevent the changed moving route from not matching the moving status of the mobile body and becoming an ineffective moving route.

According to the information processing apparatus 100, when detecting to change the moving route of the mobile body, it is possible to acquire the time required for changing the moving route of the mobile body on the basis of the destinations unvisited by the mobile body among the plurality of destinations, using the predetermined model. Thereby, the information processing apparatus 100 can easily acquire the time required with high accuracy.

According to the information processing apparatus 100, it is possible to determine the remaining destinations excluding the visitable destinations in the acquired time required and the destinations planned to be visited next after the acquired time required, among the destinations unvisited by the mobile body, as the destinations as change target for changing the visit plan. Thereby, the information processing apparatus 100 can easily prevent the moving route of each mobile body from becoming an ineffective moving route.

Note that the change method described in the present embodiment may be implemented by executing a prepared program on a computer such as a personal computer (PC) or a workstation. The change program described in the present embodiment is executed by being recorded on a computer-readable recording medium and being read from the recording medium by the computer. The recording medium is a hard disk, a flexible disk, a compact disc (CD)-ROM, a magneto optical disc (MO), a digital versatile disc (DVD), or the like. Furthermore, the change program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a moving route change program for causing a computer to execute a process comprising:
detecting to change a moving route of a mobile body that passes through a plurality of destinations planned to be visited by the mobile body;
when detecting to change the moving route of the mobile body, acquiring a remaining time to when the mobile body visits, or a remaining time to when the mobile body departs, after visit, a destination unvisited by the mobile body, among the plurality of destinations;
determining a destination as a change target that changes a visit plan, among destinations unvisited by the mobile body among the plurality of destinations, on a basis of the acquired remaining time; and
changing the moving route of the mobile body on a basis of the determined destination.

2. The non-transitory computer-readable recording medium according to claim 1, wherein the determining includes
specifying a number of destinations for which the visit plan is changeable in the acquired remaining time, among the plurality of destinations, using a model that enables calculation of a processing time for changing the visit plan, according to the number of destinations for which the visit plan is to be changed among the plurality of destinations, and determining the destination as the change target, among the destinations unvisited by the mobile body, on a basis of the specified number.

3. The non-transitory computer-readable recording medium according to claim 2, wherein the determining includes
selecting the specified number of unvisited destinations included in an area with a destination planned to be visited next by the mobile body as a reference point, among the destinations unvisited by the mobile body, and determining the selected destinations as the destinations as change targets.

4. The non-transitory computer-readable recording medium according to claim 2, wherein the determining includes
selecting the specified number of unvisited destinations included in an area with a starting point of the mobile body as a reference point, among the destinations unvisited by the mobile body, and determining the selected destinations as the destinations as change targets.

5. The non-transitory computer-readable recording medium according to claim 3, wherein the area is set on a basis of a linear distance from the reference point.

6. The non-transitory computer-readable recording medium according to claim 3, wherein the area is set on a basis of a travel time from the reference point.

7. The non-transitory computer-readable recording medium according to claim 1, wherein the acquiring includes
acquiring a remaining time to when the mobile body visits, or a remaining time to when the mobile body departs, after visit, a destination planned to be visited next by the mobile body, among the destinations unvisited by the mobile body.

8. The non-transitory computer-readable recording medium according to claim 1, the process further comprising:
when detecting to change the moving route of the mobile body, acquiring a time required for changing the moving route of the mobile body, on a basis of the destinations unvisited by the mobile body, among the plurality of destinations;
determining the destination as the change target, among the destinations unvisited by the mobile body, on a basis of the acquired time required; and
changing the moving route of the mobile body on a basis of the determined destination.

9. A moving route change method performed by a computer, the method comprising:
detecting to change a moving route of a mobile body that passes through a plurality of destinations planned to be visited by the mobile body;
when detecting to change the moving route of the mobile body, acquiring a remaining time to when the mobile body visits, or a remaining time to when the mobile body departs, after visit, a destination unvisited by the mobile body, among the plurality of destinations;
determining a destination as a change target that changes a visit plan, among destinations unvisited by the mobile body among the plurality of destinations, on a basis of the acquired remaining time; and
changing the moving route of the mobile body on a basis of the determined destination.

10. An information processing apparatus comprising:
a memory, and
a processor coupled to the memory and configured to:
detect to change a moving route of a mobile body that passes through a plurality of destinations planned to be visited by the mobile body;
when to change the moving route of the mobile body is detected, acquire a remaining time to when the mobile body visits, or a remaining time to when the mobile body departs, after visit, a destination unvisited by the mobile body, among the plurality of destinations;
determine a destination as a change target that changes a visit plan, among destinations unvisited by the mobile body among the plurality of destinations, on a basis of the acquired remaining time; and
change the moving route of the mobile body on a basis of the determined destination.

11. A non-transitory computer-readable recording medium storing a moving route change program for causing a computer to execute processing comprising:
detecting to change a moving route of a mobile body that passes through a plurality of destinations planned to be visited by the mobile body;
when detecting to change the moving route of the mobile body, acquiring a time required for changing the moving route of the mobile body on a basis of a destination unvisited by the mobile body, among the plurality of destinations;
determining a destination as a change target that changes a visit plan, among destinations unvisited by the mobile body among the plurality of destinations, on a basis of the acquired time required; and
changing the moving route of the mobile body on a basis of the determined destination.

12. The non-transitory computer-readable recording medium according to claim 11, wherein the acquiring includes
acquiring the time required for changing the moving route of the mobile body, on a basis of the destination unvisited by the mobile body, among the plurality of destinations, using a model that enables calculation of a processing time for changing the visit plan, according to the number of destinations for which the visit plan is to be changed among the plurality of destinations.

13. The non-transitory computer-readable recording medium according to claim 11, wherein the determining includes
determining one or more remaining destinations excluding destinations visitable within the acquired time required and a destination planned to be visited next after the acquired time required, among the destinations unvisited by the mobile body, as the destination as the change target that changes a visit plan.

14. A moving route change method performed by a computer, the method comprising:
detecting to change a moving route of a mobile body that passes through a plurality of destinations planned to be visited by the mobile body;
when detecting to change the moving route of the mobile body, acquiring a time required for changing the moving route of the mobile body on a basis of a destination unvisited by the mobile body, among the plurality of destinations;
determining a destination as a change target that changes a visit plan, among destinations unvisited by the mobile body among the plurality of destinations, on a basis of the acquired time required; and
changing the moving route of the mobile body on a basis of the determined destination.

15. An information processing apparatus comprising:
a memory, and
a processor coupled to the memory and configured to:
detect to change a moving route of a mobile body that passes through a plurality of destinations planned to be visited by the mobile body;
when to change the moving route of the mobile body is detected, acquire a time required for changing the moving route of the mobile body on a basis of a destination unvisited by the mobile body, among the plurality of destinations;
determine a destination as a change target that changes a visit plan, among destinations unvisited by the mobile body among the plurality of destinations, on a basis of the acquired time required; and
change the moving route of the mobile body on a basis of the determined destination.
